(19) United States
(12) Patent Application Publication
(10) Pub. No.: US 2016/0155212 A1
(43) Pub. Date: Jun. 2, 2016

(54) IMAGE DISPLAY APPARATUS AND IMAGE DISPLAY METHOD

(71) Applicant: CANON KABUSHIKI KAISHA, Tokyo (JP)

(72) Inventor: Taku Ogasawara, Tokyo (JP)

(21) Appl. No.: 14/950,966

(22) Filed: Nov. 24, 2015

(30) Foreign Application Priority Data
Nov. 28, 2014 (JP) 2014-242442

(51) Int. Cl. G06T 3/40; G06T 11/60; G06T 13/80; G06F 3/0484

(52) U.S. Cl. CPC G06T 3/40; G06F 3/04845; G06T 11/60; G06T 13/80

(57) ABSTRACT

There is provided an image display apparatus capable of emphasizing a desired portion in an image with a simple operation, and further displaying the portion in an enlarged manner, when the image is displayed. The image display apparatus draws a marker on the image displayed on a screen based on an instruction from a user, and displays an image of a region containing the drawn marker in an enlarged manner on the screen if it is determined that an instruction for displaying the region containing the drawn marker in the enlarged manner is issued from the user.

### BACKGROUND

1. Technical Field

The present disclosure relates to a technique for displaying a partial region in a page image.

2. Description of the Related Art

In a common presentation, slides are explained one by one while a single slide is projected onto a projector screen. However, depending on a structure of a presentation document, it may be difficult for an audience to understand which portion a presenter is explaining in the slide, or the audience may grow bored because an explanation of a single slide continues for a long time with a display thereof unchanged.

On the other hand, as an image display method for displaying a page image, there is a display method developed in consideration of displaying the page image on a small screen of a mobile terminal, such as a smart-phone. Japanese Patent Application Laid-Open No. 2013-190870 discusses that partial regions in the page image are automatically recognized according to document components such as a text and a photograph included in the page image. Then, with a simple operation such as tapping a button, the automatically recognized partial regions can be displayed sequentially at respective enlargement ratios for each of the partial regions that are set to fit to the small screen of the mobile terminal. If the mobile terminal discussed in Japanese Patent Application Laid-Open No. 2013-190870 is connected to the projector and this method is used for a presentation that is carried out while an image displayed on the mobile terminal is projected onto the projector screen, the partial regions recognized in advance are displayed sequentially at the respective enlargement ratios for each of the partial regions, which can make it easier for the audience to understand which partial region the presenter is explaining in the slide. Further, the partial regions are explained while being displayed in an enlarged manner sequentially one by one, which can also keep the audience from being bored.

However, according to the display method discussed in Japanese Patent Application Laid-Open No. 2013-190870, the partial regions should be explained in an order of the partial regions that is set when the page image is processed by the automatic recognition processing. On the other hand, in the presentation, the presenter may want to emphatically explain a region different from the partial regions preset by the presenter so that this region can leave a stronger impression on the audience depending on a status and/or conditions of the audience.

In such a case, the user needs to make an explanation while changing a display region by performing an enlarging/reducing operation such as a pinch-in/pinch-out or a moving operation such as a swipe, while displaying the page image, instead of displaying the partial regions in the preset order. These gesture operations on the mobile terminal are cumbersome compared to the simple operation such as tapping a button, which may cause distracting the attention of the audience due to clumsiness in the operation despite the fact that the presenter wants to explain this region emphatically toward the impression of the audience.

### SUMMARY

According to an aspect of the present invention, an image display apparatus includes a display unit configured to display an image on a screen, a marker drawing unit configured to draw a marker on the image displayed by the display unit based on an instruction from a user, a determination unit configured to determine whether an instruction for displaying a region containing the drawn marker in an enlarged manner is issued from the user, and an enlarged display unit configured to display an image of the region containing the drawn marker in the enlarged manner on the screen if the determination unit determines that the instruction is issued.

When an image is displayed, a desired portion in the image can be emphasized with the simple operation, and further, this portion can be displayed in an enlarged manner.

Further features of the present invention will become apparent from the following description of exemplary embodiments with reference to the attached drawings.

### BRIEF DESCRIPTION OF THE DRAWINGS

FIG. 1 illustrates a hardware configuration of a mobile terminal.

FIGS. 2A and 2B are processing block diagrams of the mobile terminal.

FIG. 3 illustrates a display screen of the mobile terminal.

FIG. 4 is a flowchart illustrating automatic recognition processing for partial regions.

FIGS. 5A, 5B, and 5C illustrate a page image and the automatically recognized partial regions.

FIG. 6 is a flowchart illustrating management processing for the partial regions.

FIG. 7 illustrates a management table for the partial regions.

FIG. 8 is a flowchart illustrating display processing for a partial region group.

FIG. 9 is a flowchart illustrating display range determination processing for the partial region.

FIGS. 10A, 10B, 10C, 10D, 10E, and 10F illustrate a screen transition during execution of the display processing for the partial regions.

FIG. 11 is a flowchart illustrating marker drawing processing.

FIGS. 12A, 12B, 12C, and 12D illustrate a display example of the marker drawing.

FIG. 13 is a flowchart illustrating marker region specification processing.

FIGS. 14A, 14B, 14C, and 14D illustrate an example of the marker region specification processing.

FIG. 15 (consisting of FIGS. 15A and 15B) is a flowchart illustrating enlarged display processing for the maker region and ending processing for the enlarged display.

FIGS. 16A, 16B, 16C, 16D, 16E, 16F, and 16G illustrate an example of a screen transition during the enlarged display processing for the marker region and the ending processing for the enlarged display.

FIGS. 17A, 17B, 17C, 17D, 17E, 17F, and 17G illustrate an example of a screen transition during the enlarged display processing for the marker region and the ending processing for the enlarged display when a linear marker is drawn.

FIG. 18 is a flowchart illustrating marker region specification processing according to a second exemplary embodiment.

FIGS. 19A and 19B illustrate an example of the marker region specification processing according to the second exemplary embodiment.

FIGS. 20A, 20B, 20C, 20D, 20E, 20F, and 20G illustrate an example of a screen transition during the enlarged display processing for the marker region and the ending processing for the enlarged display according to the second exemplary embodiment.

### DESCRIPTION OF THE EMBODIMENTS

In the following description, exemplary embodiments for embodying the present invention will be described with reference to the drawings.

### <Hardware Configuration of Mobile Terminal>

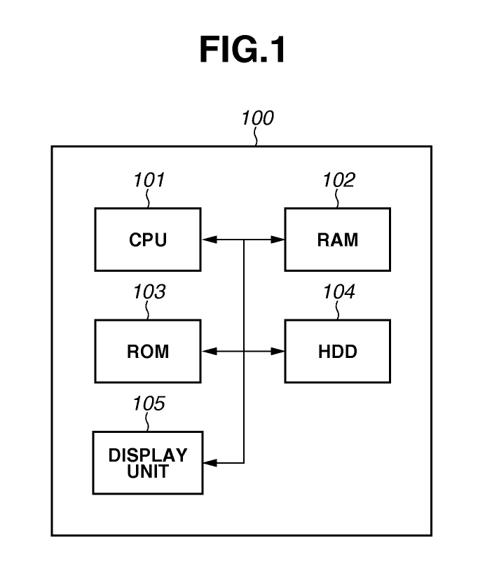

FIG. 1 illustrates an example of a hardware configuration of a mobile terminal (an image display apparatus, such as a portable terminal) 100 according to a first exemplary embodiment. The mobile terminal 100 includes a central processing unit (CPU) 101, a random access memory (RAM) 102, a read only memory (ROM) 103, a hard disk drive (HDD) 104, and a display unit 105.

The CPU 101 controls an operation of each of processing units of the mobile terminal 100 by executing a program stored in the ROM 103. The RAM 102 is a memory used as a work memory when the CPU 101 executes the program. The HDD 104 is a storage device that stores various kinds of data such as image data to be displayed, and is a hard disk or a semiconductor nonvolatile memory such as a flash memory. The ROM 103 stores an image display program to be executed by the CPU 101, and the like. The image display program is provided by distribution of a recording medium, a download from a network, or the like. The display unit 105 displays a page image and the like under control by the CPU 101. A screen of the display unit 105 is configured of, for example, a liquid crystal touch panel, and a liquid crystal driving circuit drives liquid crystals under the control by the CPU 101, thereby causing the page image and the like to be displayed on the touch panel. Further, the display unit 105 receives a touch operation (e.g., tap and swipe) from a user. The display unit 105 notifies the CPU 101 of a content of the operation received from the user. The CPU 101 switches the page image displayed on the display unit 105 according to the content of the received operation. A video image displayed on the display unit 105 may be displayed on a screen of a projector, a large-screen television set, or the like connected via a wired or wireless connection by being mirrored thereon. Such a configuration also allows a presenter to use the video image for a presentation by using the projector while operating the video image on the mobile terminal 100, such as a smart-phone.

### <Processing Units of Mobile Terminal>

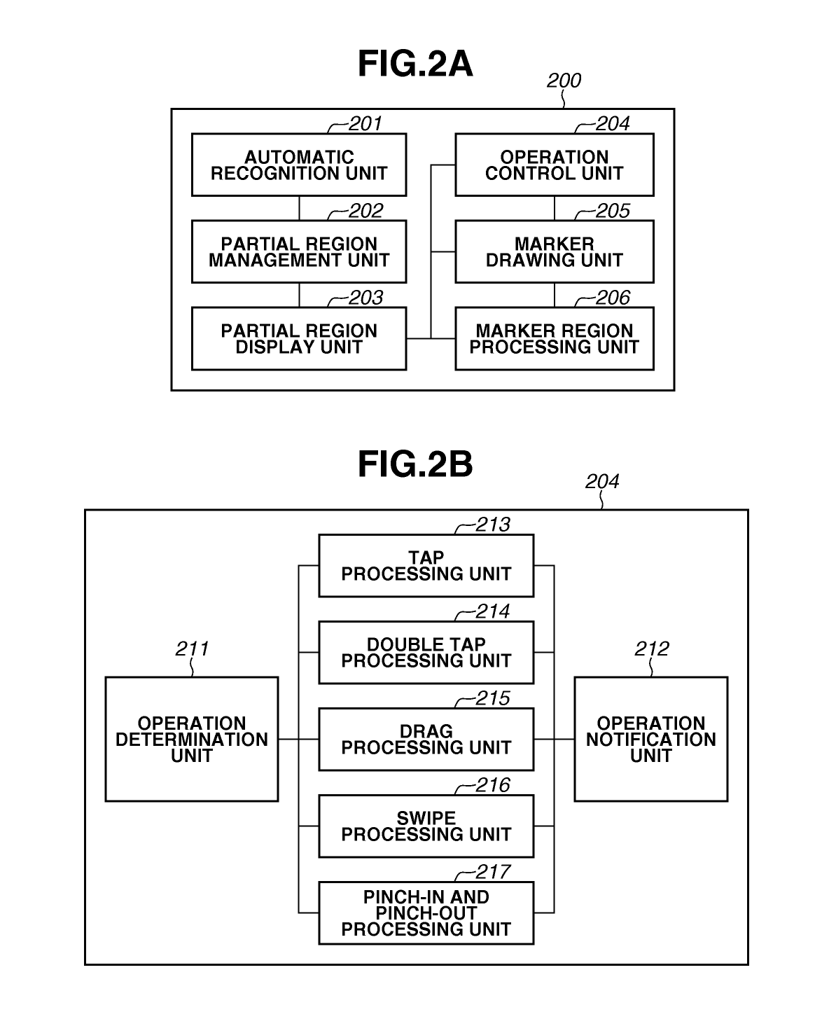

FIG. 2A is a schematic diagram when the mobile terminal 100 according to the present exemplary embodiment functions as each of the processing units by executing the program. The processing units realized by the mobile terminal 100 include an automatic recognition processing unit 201, a partial region management unit 202, a partial region display unit 203, an operation control unit 204, a marker drawing unit 205, and a marker region processing unit 206. In other words, the mobile terminal 100 functions as the automatic recognition processing unit 201, the partial region management unit 202, the partial region display unit 203, the operation control unit 204, the marker drawing unit 205, and the marker region processing unit 206 by causing the CPU 101 to execute the program such as the image display program stored in the ROM 103.

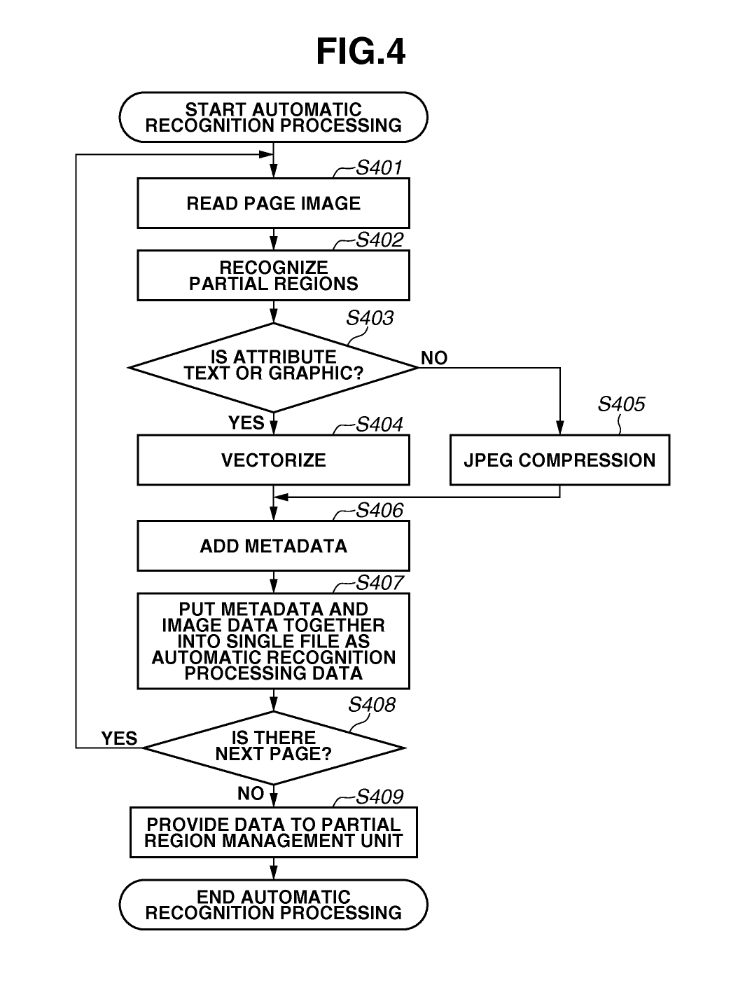

The automatic recognition processing unit 201 automatically recognizes a plurality of partial regions in the page image by identifying document components such as a text, a figure, and a table included in the page image. A flowchart in FIG. 4 illustrates a procedure of automatic recognition processing for the partial regions.

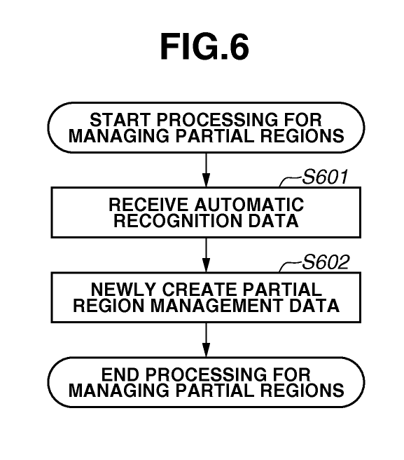

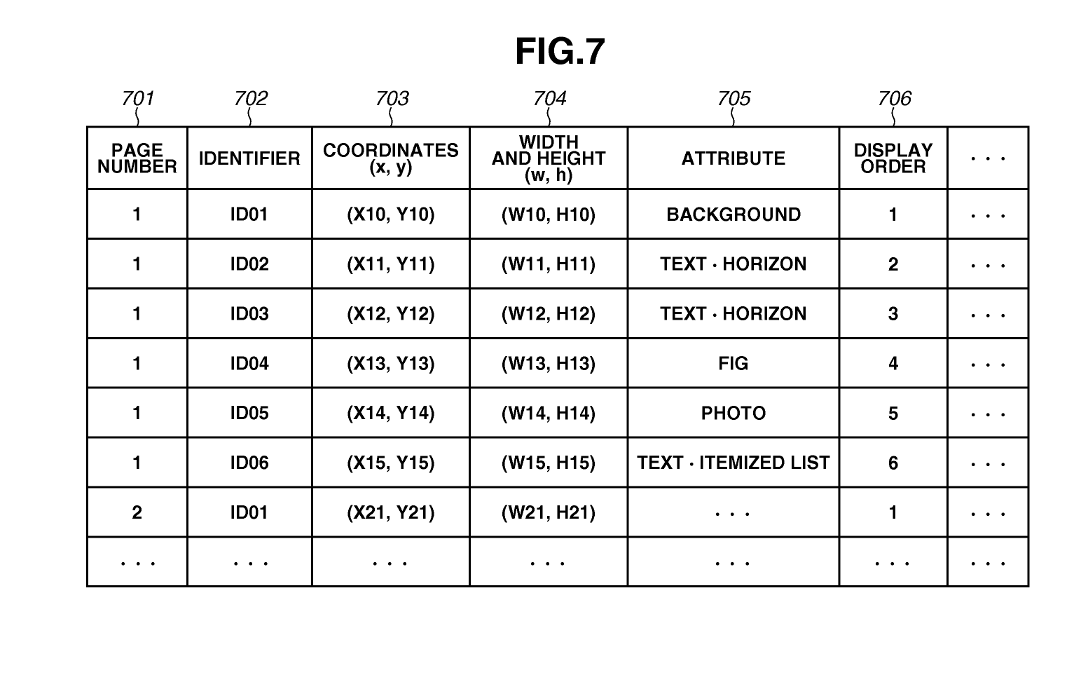

The partial region management unit 202 manages data such as coordinates, and widths and heights of the partial regions automatically recognized by the automatic recognition processing unit 201. A flowchart in FIG. 6 illustrates a procedure of management processing for the data of the partial regions, and FIG. 7 illustrates a management table for the partial regions.

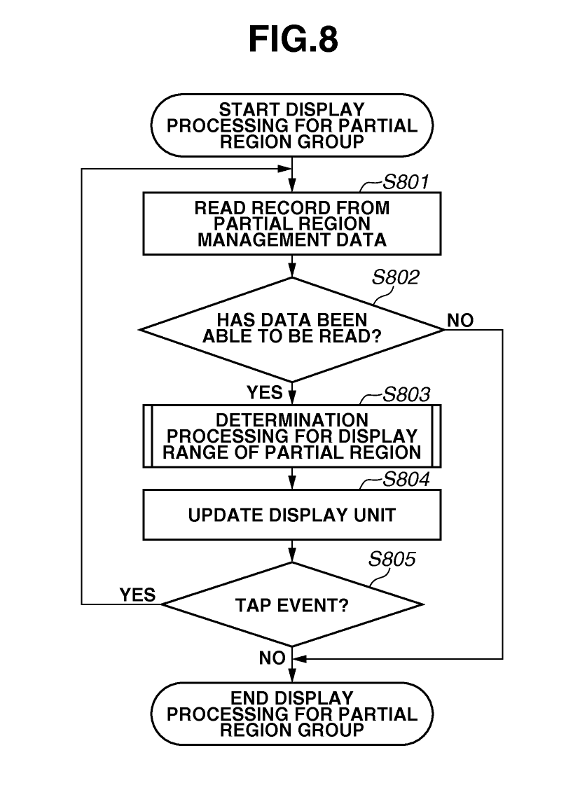

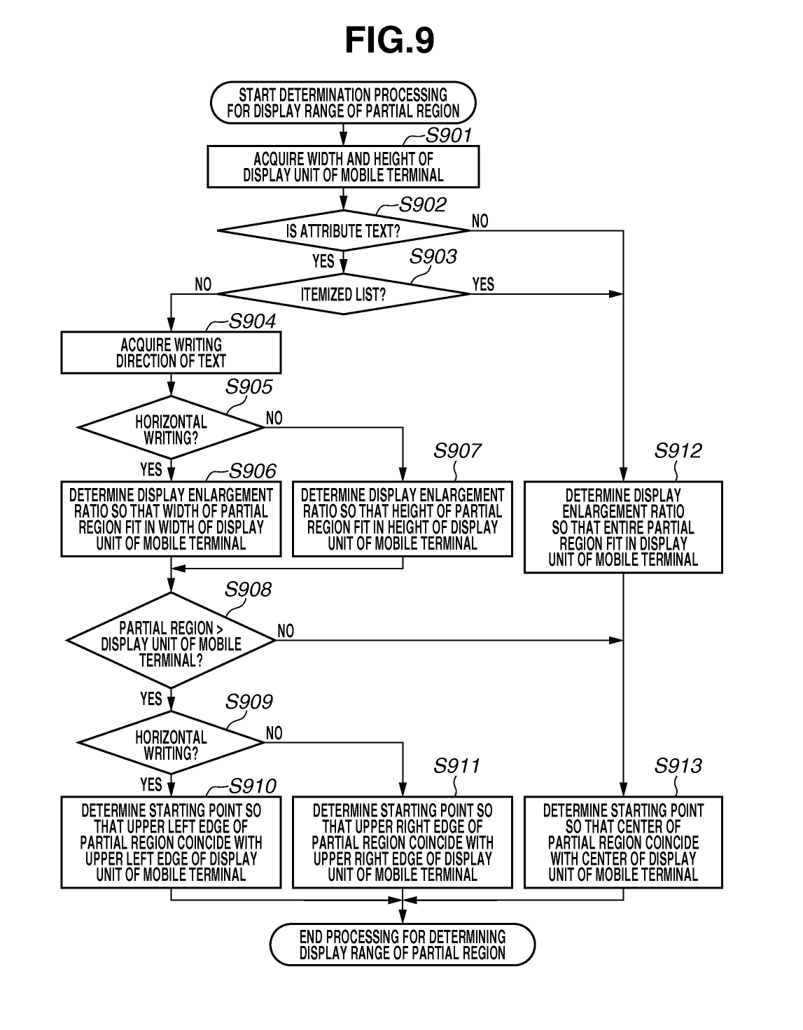

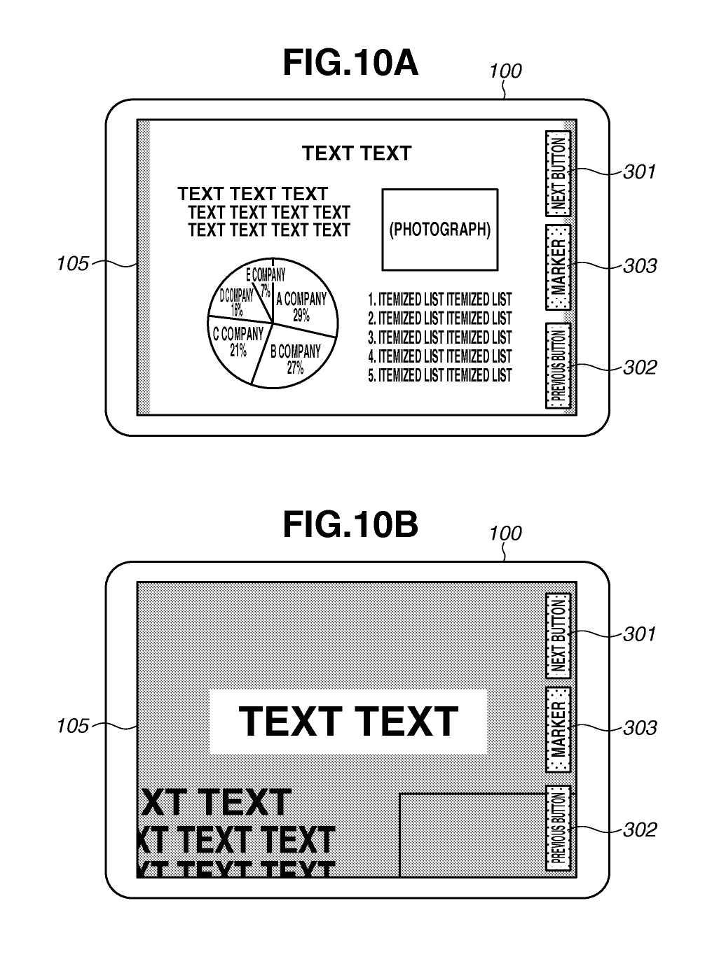

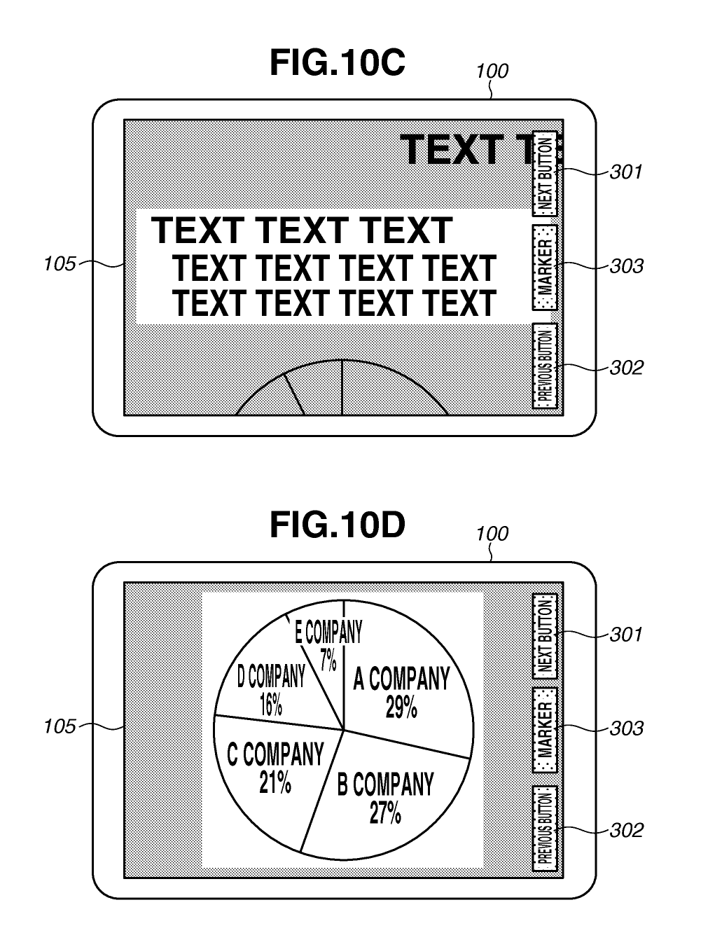

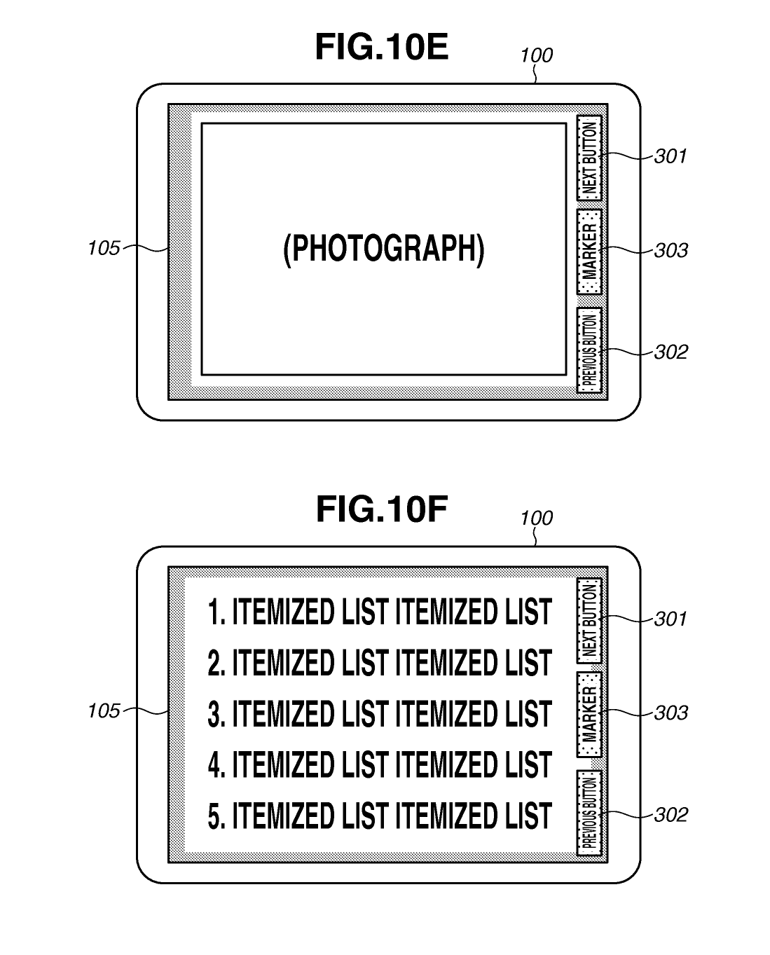

The partial region display unit 203 determines a display enlargement ratio of each of the partial regions from the coordinates, the width and the height, and the like of the partial region managed by the partial region management unit 202, and displays each of the partial regions on the display unit 105 of the mobile terminal 100 at the enlargement ratio for each of the partial regions. Flowcharts in FIGS. 8 and 9 illustrate a procedure of display processing for the partial regions, and FIGS. 10A to 10F illustrate a screen transition during execution of the display processing for the partial regions.

The operation control unit 204 receives the operation from the user onto the display unit 105 of the mobile terminal 100, and performs control according to the operation. Types of the user operation include the tap, a double tap, the swipe, the pinch-in and the pinch-out, and the like. When receiving these operations, the operation control unit 204 notifies the partial region display unit 203, the marker drawing unit 205, or the marker region processing unit 206 of the type of the operation, coordinates on which the operation is performed, a movement distance, and/or the like. FIG. 2B illustrates detailed processing blocks of the operation control unit 204.

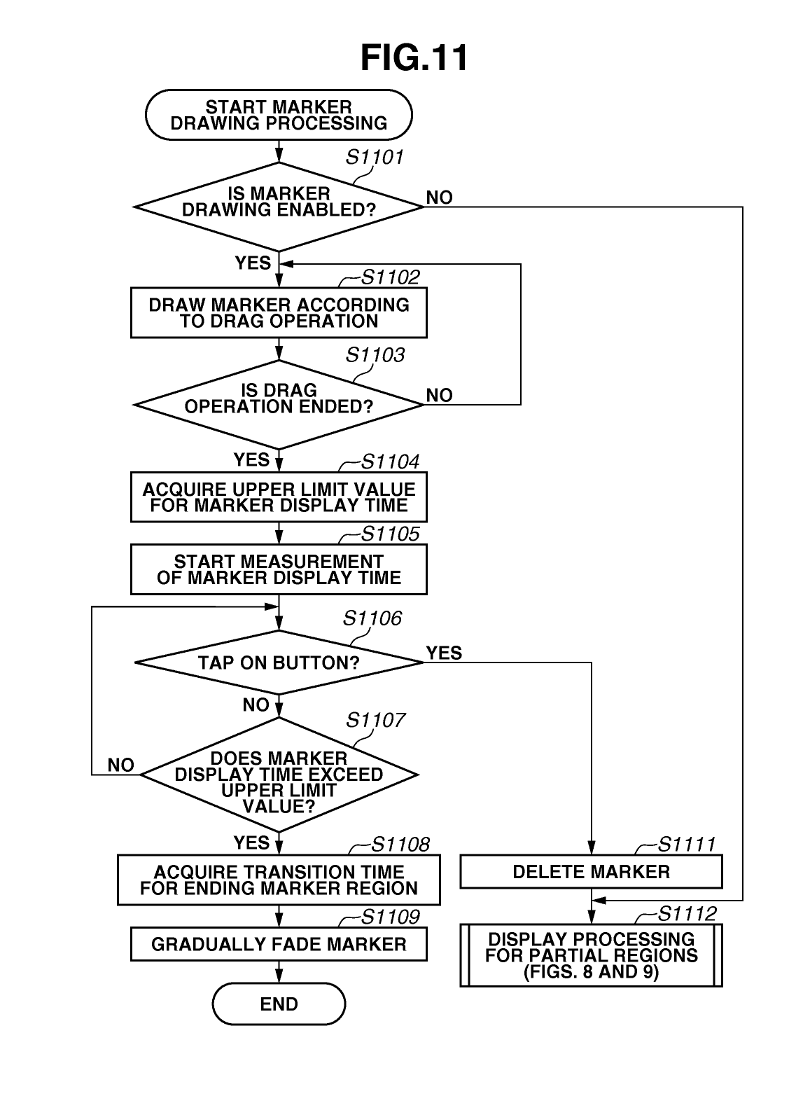

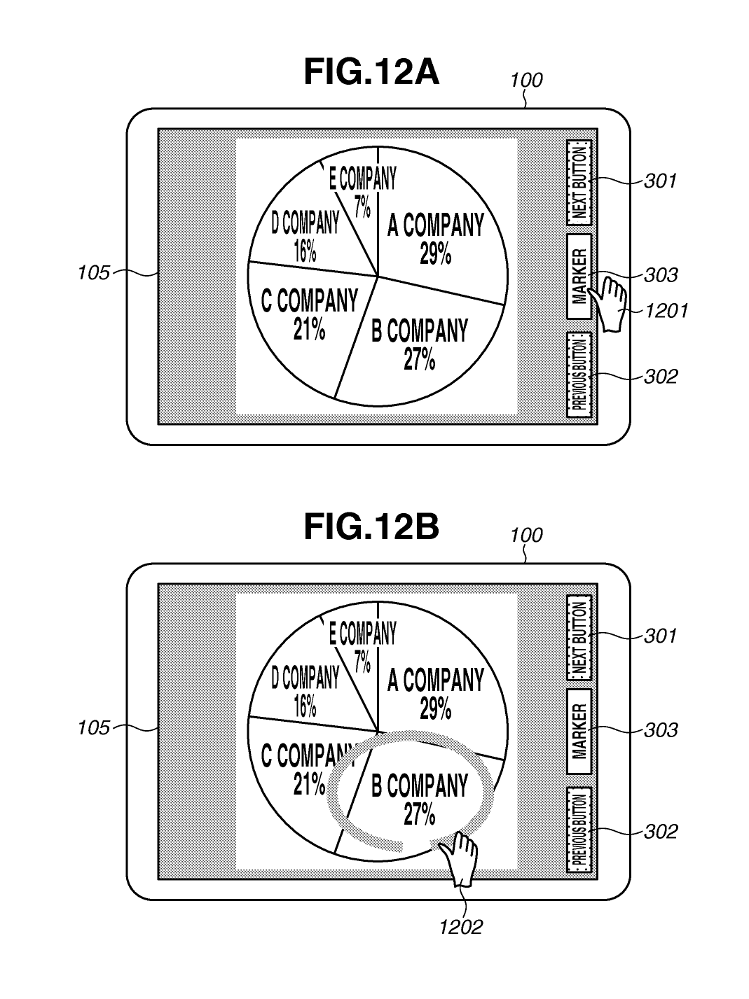

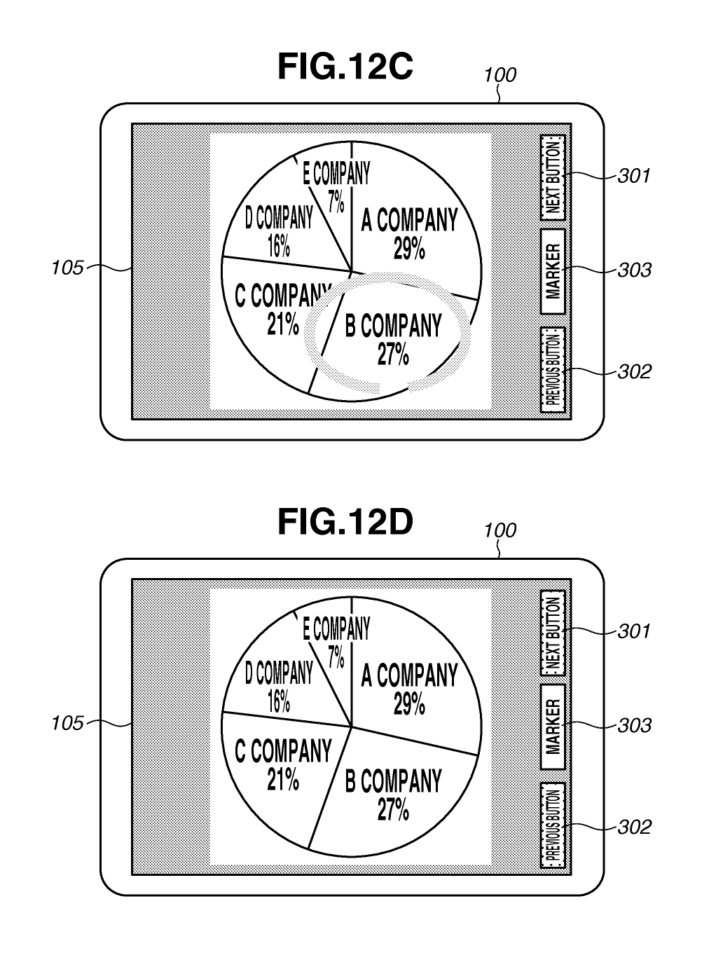

The marker drawing unit 205 draws a marker on a partial region that the partial region display unit 203 currently displays according to a drag operation from the user when the mobile terminal 100 is set to a marker drawing mode. Actually, the marker drawing unit 205 is notified of the drag operation received from the user as a drag event via the operation control unit 204, and the marker drawing unit 205 draws the marker according to the coordinates contained in the drag event. FIG. 11 illustrates marker drawing processing, and FIGS. 12A to 12D illustrate an example of a display of the marker drawing.

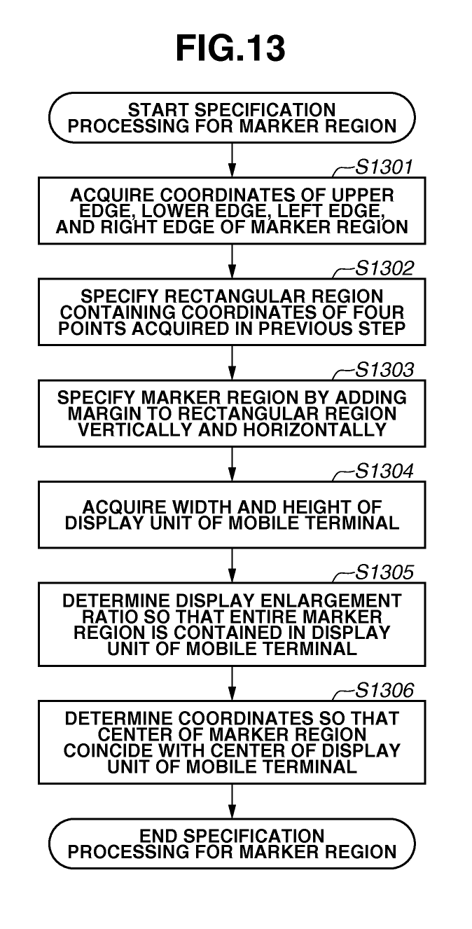

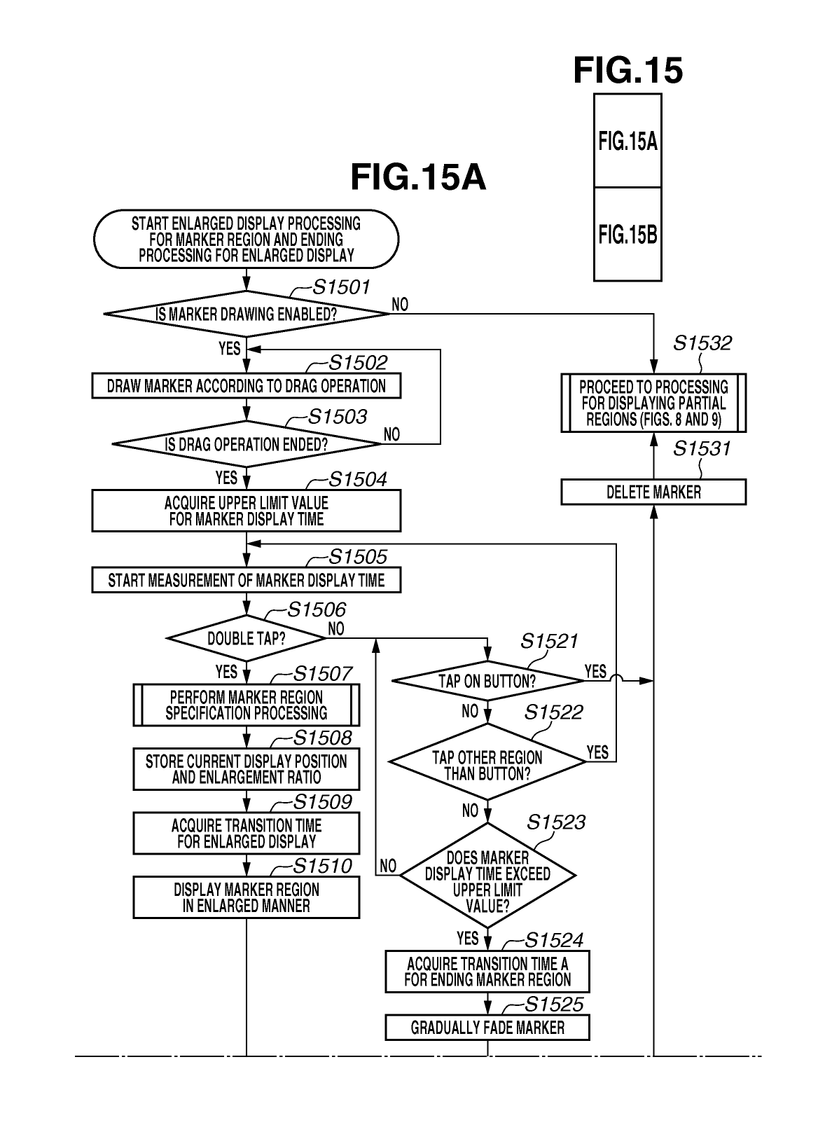

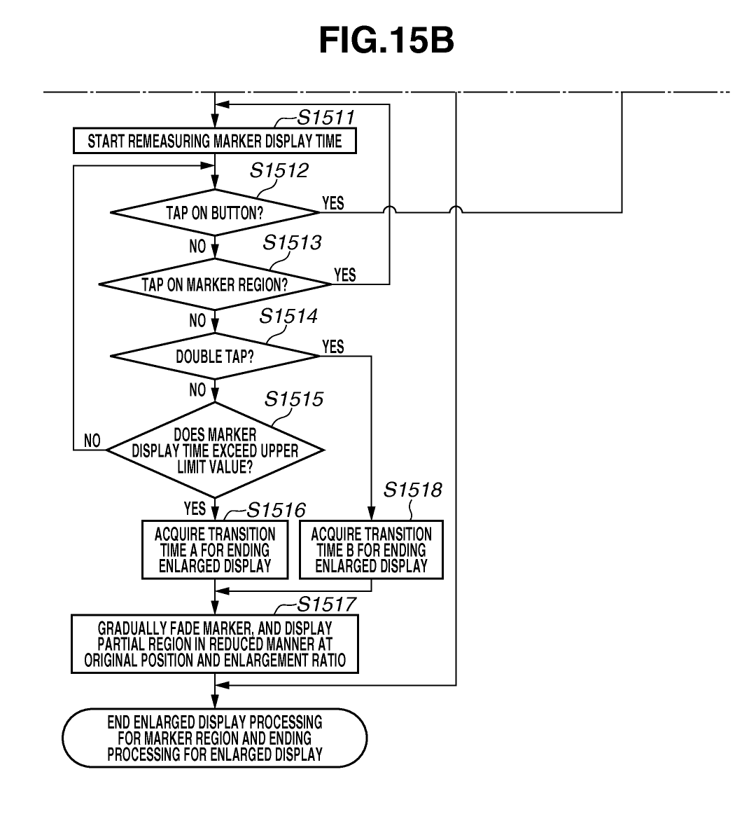

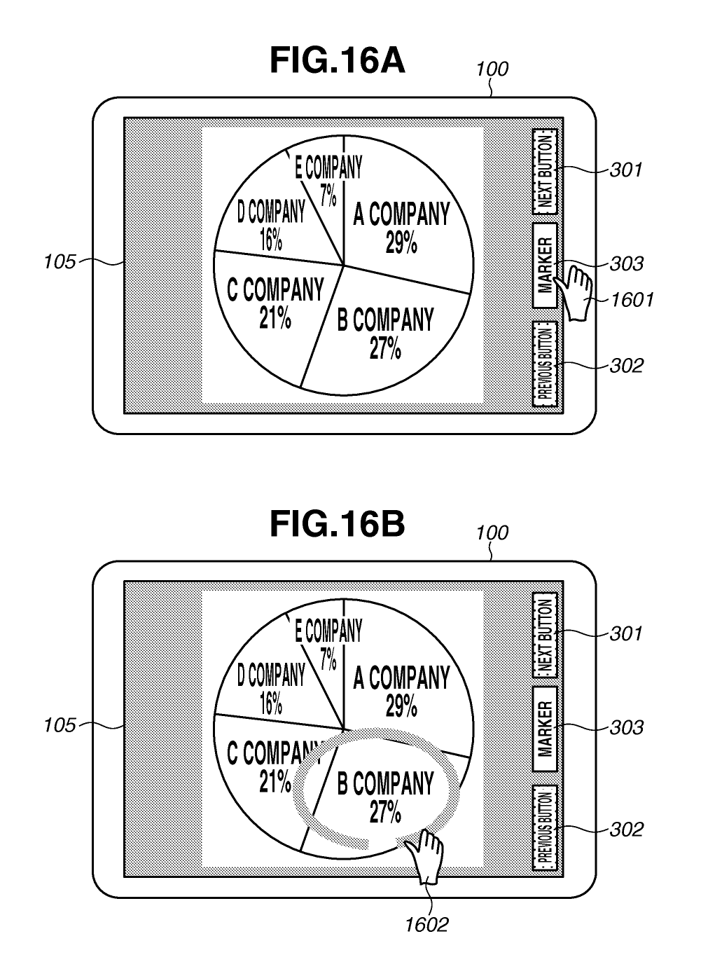

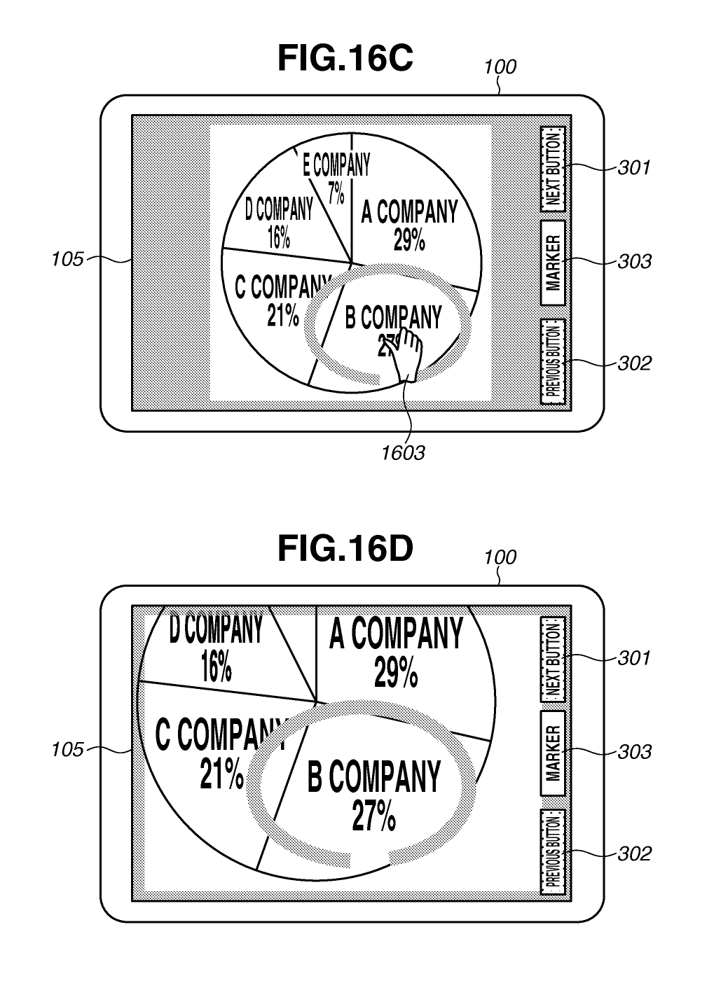

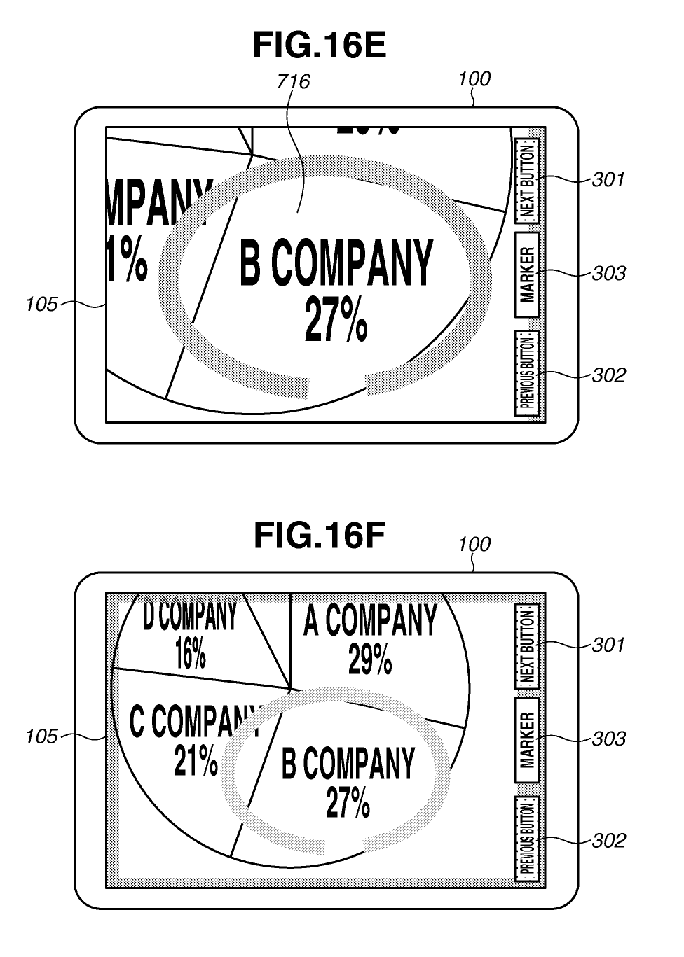

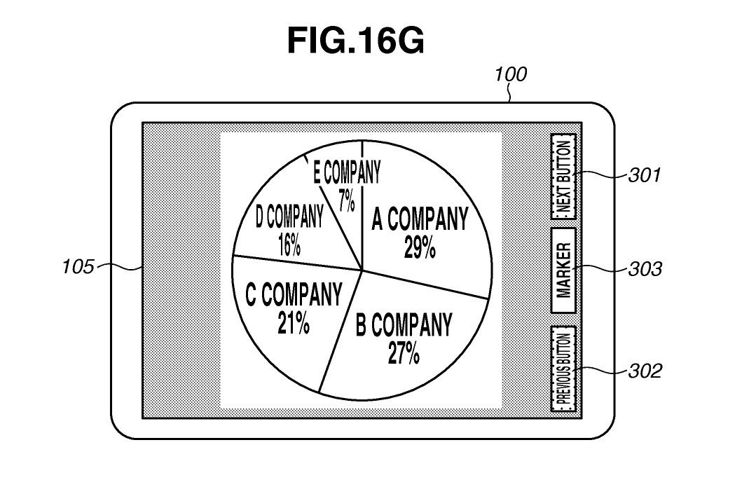

The marker region processing unit 206 performs marker region specification processing, the marker region enlarged display processing, the marker region enlarged display ending processing, and the like with use of the marker drawn by the marker drawing unit 205. FIG. 13 illustrates the marker region specification processing, and FIG. 15 (consisting of FIGS. 15A and 15B) illustrates the marker region enlarged display processing and the marker region enlarged display ending processing. Further, FIGS. 16A to 16G illustrate an example of a screen transition during the marker region enlarged display processing.

FIG. 2B is a block diagram illustrating each of processing units included in the operation control unit 204. The operation control unit 204 includes an operation determination unit 211, an operation notification unit 212, a tap processing unit 213, a double tap processing unit 214, a drag processing unit 215, a swipe processing unit 216, and a pinch-in and pinch-out processing unit 217.

When receiving the operation performed by the user onto the display unit 105 of the mobile terminal 100, the operation determination unit 211 determines the type of this operation, and passes processing to any of the processing units 213 to 217. The types of the operation include the tap operation, the double tap operation, the drag operation, the swipe operation, the pinch-in and pinch-out operations, and the like.

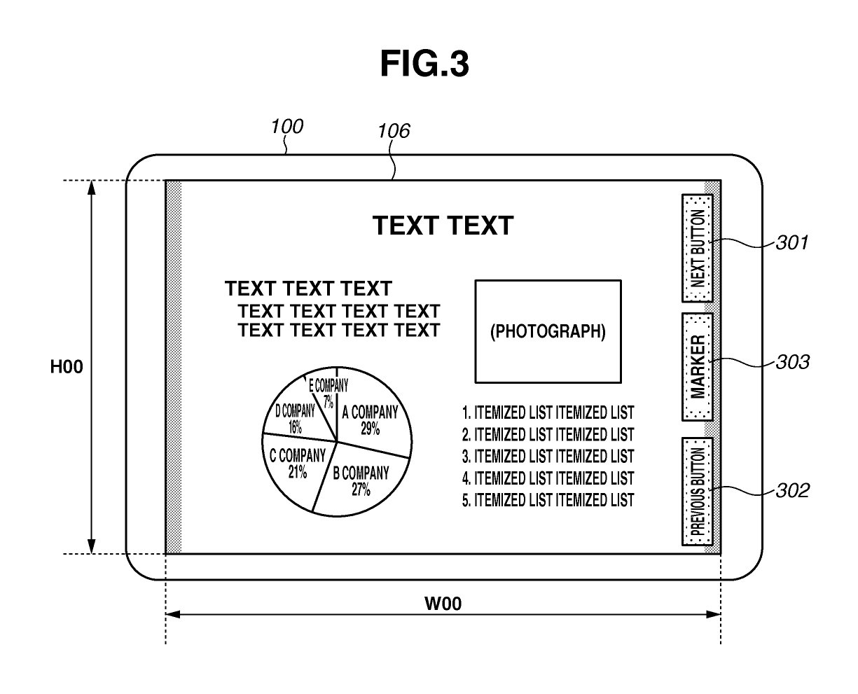

The tap processing unit 213 performs processing according to tapped coordinates, if the operation determination unit 211 determines that the operation received from the user is the tap operation. The tap processing unit 213 determines whether the tapped coordinates are located within a range where any of a “next button 301”, a “previous button 302”, and a “marker button 303” illustrated in FIG. 3 is displayed. The tap processing unit 213 notifies the partial region display unit 203 or the marker region processing unit 206 according to the tapped button 301, 302, or 303 via the operation notification unit 212. This notification is referred to as a tap event. The tap event contains the type of the tapped button 301, 302, or 303.

If determining that the tap operation is performed on the next button 301 or the previous button 302, the tap processing unit 213 notifies the partial region display unit 203 of the tap even via the operation notification unit 212. When receiving the tap event on the next button 301 (or the previous button 302), the partial region display unit 203 displays a partial region that should be displayed next after (or a partial region that should be displayed before) the currently displayed partial region according to a preset display order. This display processing for a partial region group will be described in detail below with reference to FIG. 8.

Further, if determining that the tap operation is performed on the marker button 303, the tap processing unit 213 notifies the marker drawing unit 205 of the tap event via the operation notification unit 212. The tap event on the marker button 303 is used to enable or disable the marker drawing mode, and the marker button 303 is a toggle switch. Processing performed when the marker drawing unit 205 is notified of the tap event will be described in detail below with reference to the marker drawing processing, which is illustrated in FIG. 11.

The double tap processing unit 214 performs processing according to a double-tapped position, if the operation determination unit 211 determines that the operation received from the user is the double tap operation. If the operation determination unit 211 determines that the double tap operation is performed when the marker drawing mode is enabled, the double tap processing unit 214 notifies the marker region processing unit 206 of a double tap event via the operation notification unit 212. If being notified of the double tap event when the marker drawing mode is enabled, the marker region processing unit 206 performs the display processing for the marker region where the marker is drawn in an enlarged manner, or the ending processing for this enlarged display. Details thereof will be described in a description of the marker region enlarged display processing, which is illustrated in FIG. 15.

The drag processing unit 215 performs processing, if the operation determination unit 211 determines that the operation received from the user is the drag operation. If the operation determination unit 211 determines that the drag operation is performed, the drag processing unit 215 notifies the marker drawing unit 205 of the drag event via the operation notification unit 212. The drag event contains coordinates of a position where the drag operation is performed on the display unit 105 of the mobile terminal 100. When being notified of the drag event, the marker drawing unit 205 draws the marker according to the position coordinates contained in this drag event. The marker drawing will be described in detail below with reference to the marker drawing processing, which is illustrated in FIG. 11.

The swipe processing unit 216 performs processing, if the operation determination unit 211 determines that the operation received from the user is the swipe operation. If the operation determination unit 211 determines that the swipe operation is performed, the swipe processing unit 216 notifies the partial region display unit 203 of a swipe event via the operation notification unit 212. When being notified of the swipe event, the partial region display unit 203 performs processing for turning the currently displayed page image (processing for displaying a next or previous page image) if the page image is currently entirely displayed on the screen, or performs processing for moving a position displayed in an enlarged manner if the page image is currently displayed in the enlarged manner.

The pinch-in and pinch-out processing unit 217 performs processing, if the operation determination unit 211 determines that the operation received from the user is the pinch-in or pinch-out operation. If the operation determination unit 211 determines that the pinch-in operation or the pinch-out operation is performed, the pinch-in and pinch-out processing unit 217 notifies the partial region display unit 203 of a pinch-in/pinch-out event via the operation notification unit 212. This event contains, for example, a movement distance of the pinch-in/pinch-out operation. When being notified of the pinch-in/pinch-out event, the partial region display unit 203 displays the currently displayed partial region in a reduced manner or in an enlarged manner according to the movement distance that the partial region display unit 203 is notified of via the pinch-in event or the pinch-out event.

### <Example of Display on Mobile Terminal>

FIG. 3 illustrates a configuration of the display unit 105 of the mobile terminal 100 according to the present exemplary embodiment. In the present exemplary embodiment, the display unit 105 of the mobile terminal 100 has a width of W00 and a height of H00. The mobile terminal 100 can be held with its orientation rotated at 90 degrees, and the display unit 105 has a width of H00 and a height of W00 in this case. The page image is displayed on the display unit 105, and the next button 301, the previous button 302, and the marker button 303 are displayed on an edge side of the display unit 105.

The next button 301 or the previous button 302 is a button to receive a user's instruction to display a partial region next or previous to the currently displayed partial region in the display order. The display processing for the partial region group will be described in detail below with reference to FIG. 8. The marker button 303 is used to enable or disable the marker drawing mode, and this state is saved in the storage device such as the RAM 102. The marker button 303 is the toggle switch, and enables the marker drawing mode if being tapped when the marker drawing mode is in a disabled state. On the other hand, the marker button 303 disables the marker drawing mode if being tapped when the marker drawing mode is in an enabled state. A display state of the marker button 303 is changed according to the enablement/disablement of the marker drawing mode (for example, the marker button 303 is displayed in a display color changed according to the enablement/disablement of the marker drawing mode).

### <Automatic Recognition Processing for Partial Regions>

The automatic recognition processing unit 201 performs the automatic recognition processing for the partial regions with respect to the page image according to the procedure illustrated in FIG. 4. The processing procedure of the automatic recognition processing unit 201 is included in the image display program stored in the ROM 103, and is performed by the CPU 101.

In step S401, the automatic recognition processing unit 201 reads a page image stored in the storage device of the mobile terminal 100 (or a page image read out via a scanner) by one page. In the present exemplary embodiment, in a case where there are page images corresponding to a plurality of pages, the automatic recognition processing unit 201 reads the page images page by page to sequentially perform the automatic recognition processing.

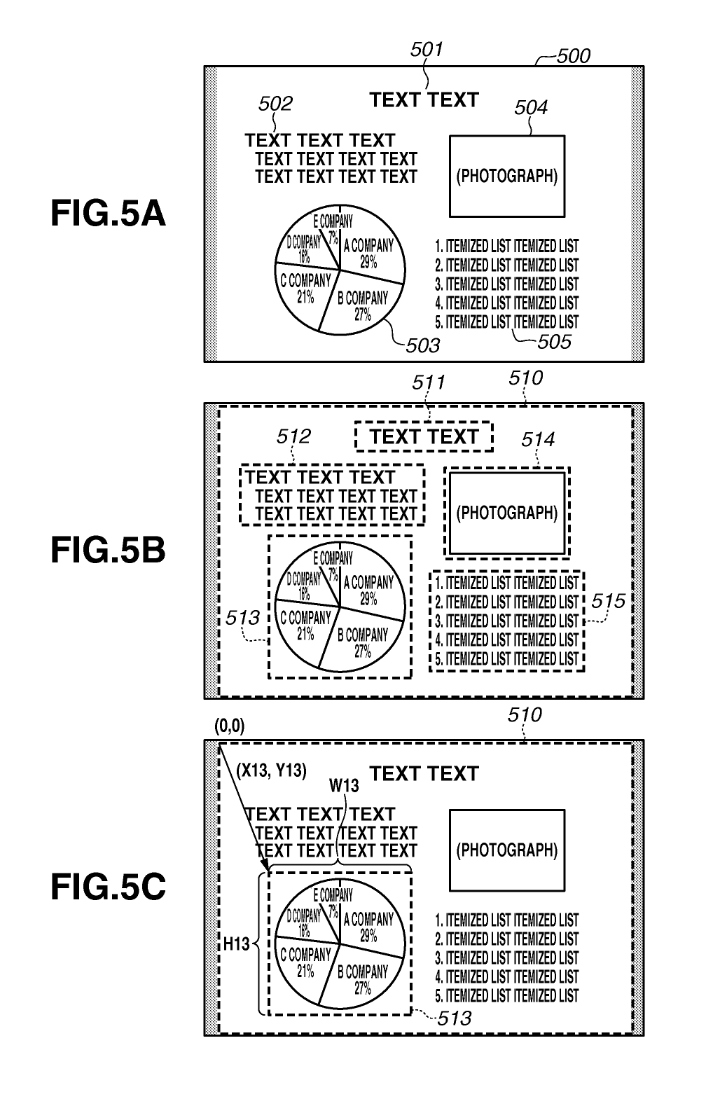

In step S402, the automatic recognition processing unit 201 recognizes a partial region for each of document components with respect to the read page image. The document components are, for example, a text region 501, a text region 502, a figure region 503, a photograph region 504, and a text (an itemized list) region 505 in a page image 500 illustrated in FIG. 5A. Then, each rectangular region surrounded by a dotted line illustrated in FIG. 5B is the partial region recognized as a result of the execution of the automatic recognition processing on the page image 500 illustrated in FIG. 5A by the automatic recognition processing unit 201. In FIG. 5B, the text region 501, the text region 502, the figure region 503, the photograph region 504, and the text (the itemized list) region 505 are automatically recognized as a partial region 511, a partial region 512, a partial region 513, a partial region 514, and a partial region 515, respectively. Further, the page image 500 is recognized as a partial region 510 indicating a background region.

The automatic recognition processing unit 201 also determines the display order according to positions and structures of the partial regions. In the example illustrated in FIG. 5B, the display order is determined to be 1, 2, 3, 4, 5, and 6 for the partial region 510, the partial region 511, the partial region 512, the partial region 513, the partial region 514, and the partial region 515, respectively.

The partial region 500 having a background attribute in the present exemplary embodiment is a region existing over a same range as the entire page image read from the storage area in step S401. Assume that coordinates of each of the automatically recognized partial regions 510 to 515, which will be described below, indicate a position in the partial region 500 having the background attribute.

In step S403, the automatic recognition processing unit 201 determines an attribute type (the text, the photograph, the graphic, or the background) with respect to each of the partial regions. If the attribute type is the text or the graphic (YES in step S403), the processing proceeds to step S404. If not (NO in step S403), the processing proceeds to step S405. The attribute types of the partial region include the text (horizontal writing or vertical writing), the graphic (a figure, a line figure, a table, or a line), the photograph, the background, and the like.

In step S404, the automatic recognition processing unit 201 converts a contour of the text or the graphic into vector data by performing vectorization processing on the partial region determined to be the text or the graphic. Converting the partial region into the vector data allows the partial region to be smoothly displayed even when being displayed in an enlarged manner.

In step S405, the automatic recognition processing unit 201 performs image processing such as Joint Photographic Experts Group (JPEG) compression on the region determined to be the photograph or the background, thereby generating image data. The image data of the background region may be generated by performing the JPEG compression on the entire page image, or may be generated by performing the JPEG compression on the page image after converting the entire page image into an image at a lower resolution.

In step S406, the automatic recognition processing unit 201 adds metadata with respect to each of the partial regions. The metadata contains the attribute, the display order, the coordinates, the width and the height, and the like of the partial region. The coordinates, and the width and the height of the partial region in the page image will be described now based on the partial region 513 illustrated in FIG. 5C. Regarding the coordinates, an origin is set at an upper left position of the region 510 having the background attribute (the region existing over the same range as the entire page image). The coordinates of the partial region 513 are expressed by a distance X13 from the origin to an upper left coordinate of the partial region 513 in an X-axis direction, and a distance Y13 from the origin to an upper left coordinate of the partial region 513 in a Y-axis direction. The width and the height are expressed by a length W13 of the partial region 513 in the X-axis direction and a length H13 of the partial region 513 in the Y-axis direction. For each of the other partial regions 510 to 512, 514, and 515, the coordinates, and the width and the height are also expressed in a similar manner.

In step S407, the automatic recognition processing unit 201 puts (archives) the metadata and the image data of each of the partial regions, which have been acquired in the previous steps, together into a single file. The data created by putting them together into the single file is referred to as automatic recognition data of the partial regions.

In step S408, the automatic recognition processing unit 201 determines whether there is a page image of a next page. If the automatic recognition processing unit 201 determines that there is a page image of a next page (YES in step S408), the processing returns to step S401. If the automatic recognition processing unit 201 determines that there is not a page image of a next page (NO in step S408), the processing proceeds to step S409.

In step S409, the automatic recognition processing unit 201 provides the partial region management unit 202 with the automatic recognition data of the partial regions that has been acquired as a result of the execution of the processing on the page images of all of the pages, and then ends the automatic recognition processing.

### <Management of Partial Regions>

The partial region management unit 202 manages the partial regions according to the procedure illustrated in FIG. 6. The partial region management unit 202 uses the partial region management table illustrated in FIG. 7. The processing procedure of the partial region management unit 202 is included in the image display program stored in the ROM 103, and is performed by the CPU 101. The partial region management table is stored in the storage area such as the RAM 202 and the HDD 204 of the mobile terminal 100.

In step S601, the partial region management unit 202 receives the automatic recognition data, which is the result of the automatic recognition processing, from the automatic recognition processing unit 201.

In step S602, the partial region management unit 202 extracts the metadata (the coordinates, the width and the height, the attribute, a page number, the display order, and the like) and the image data of each of the partial regions from the received automatic recognition data of the partial regions, and stores them into the partial region management table, like the table illustrated in FIG. 7.

FIG. 7 illustrates an example of the data stored in the partial region management table. A record of each of the partial regions is listed in a column direction of the partial region management table. In other words, each row in the partial region management table indicates the record of each of the partial regions (a partial region record). Further, each of data items is listed in a row direction in the partial region management table illustrated in FIG. 7. The data items include a page number 701, an identifier 702 of the partial region, coordinates 703, a width and a height 704, an attribute 705, and a display order 706.

The page number contained in the received automatic recognition data is stored in the page number 701. The identifier 702 is an identification (ID) for identifying the automatically recognized partial region in one page, and is assigned when the partial region management unit 202 receives the automatic recognition data and stores the received automatic recognition data into the partial region management table. The page number and the identifier allow the partial region record to be uniquely identified. For example, in a case where the six partial regions 510 to 515 are recognized as a result of the execution of the automatic recognition processing on the page image of the first page as illustrated in FIG. 5B, the partial region management unit 202 stores six partial region records identified by a page number 1 and identifiers ID01 to ID06, as indicated in the partial region management table illustrated in FIG. 7.

The XY coordinates of the partial region that are contained in the received automatic recognition data are stored in the coordinates 703. The width and the height of the partial region that are contained in the automatic recognition data are stored in the width and the height 704. The attribute of the partial region that is contained in the received automatic recognition data is stored in the attribute 705. The display order that is contained in the received automatic recognition data is stored in the display order 706.

### <Display Processing for Partial Region Group>

The partial region display unit 203 performs the display processing for the partial region group according to the procedure illustrated in FIG. 8. The partial region group refers to the plurality of partial region records stored in the partial region management table, such as the table illustrated in FIG. 7. The display processing for the partial region group refers to display processing for each of the partial regions corresponding to the partial region records sequentially at the enlargement ratio for each of the partial regions. For example, in the partial region management table illustrated in FIG. 7, the partial region group of the page 1 refers to the six partial region records identified by the page number 1 and the identifiers ID01 to ID06. The processing procedure of the partial region display unit 203 is included in the image display program stored in the ROM 103, and is performed by the CPU 101.

In step S801, the partial region display unit 203 acquires the partial region record from the partial region management table. The partial region display unit 203 first acquires the partial region record at the head of the page. For example, in the case of the first page stored in the partial region management table illustrated in FIG. 7, the partial region display unit 203 reads the partial region record identified by the identifier ID01, to which 1 is assigned as the display order, as a processing target record.

In step S802, the partial region display unit 203 determines whether the data contained in this partial region record acquired as the processing target has been able to be read correctly. If this data has been able to be read in correctly (YES in step S802), the processing proceeds to step S803. If this data has been unable to be read in correctly (NO in step S802), the partial region display unit 203 ends the display processing for the partial region group. For example, in a case where the image data has been unable to be read in, the partial region cannot be displayed. Therefore, the partial region display unit 203 ends the display processing for the partial region group in such a case.

In step S803, the partial region display unit 203 determines the enlargement ratio and coordinates of the partial region set as the display target according to the procedure of the display range determination processing for the partial region, which is indicated in the flowchart illustrated in FIG. 9. This flowchart illustrated in FIG. 9 will be described below.

In step S804, the partial region display unit 203 updates a display state of the display unit 105 of the mobile terminal 100 to display the partial region set as the present display target based on the coordinates and the display enlargement ratio of the partial region that have been determined in step S803.

If the operation control unit 204 receives the tap event on the next button 301 or the previous button 302 according to the user's operation in step S805 (YES in step S805), the processing returns to step S801. Then, the partial region display unit 203 reads the next or previous partial region record. For example, in a case where the operation control unit 204 receives the tap event on the next button 301 when the mobile terminal 100 displays the partial region identified by the identifier ID01 and provided with the display order 1 (the first place in the order) in the first page in FIG. 7, the partial region display unit 203 reads the partial region record identified by the identifier ID02, which is provided with the next display order (2). In a case where the operation control unit 204 receives the tap event on the previous button 302 when the mobile terminal 100 displays the partial region identified by the identifier ID01 and provided with the display order 1 (the first place in the order) in the first page in FIG. 7, the partial region display unit 203 determines that the partial region record has been unable to be read in step S802 because there is no partial region record before that, and then ends the display processing for the partial region group.

A screen transition on the display unit 105 during the execution of the display processing for the partial region group in the page 1 in the partial region management table illustrated in FIG. 7 will be described below with reference to FIGS. 10A to 10F.

### <Processing for Determining Display Range of Partial Region (S803)>

FIG. 9 is a flowchart illustrating details of the processing performed in the above-described step, step S803 illustrated in FIG. 8. The processing procedure illustrated in FIG. 9 is included in the image display program stored in the ROM 103, and is performed by the CPU 101.

In step S901, the partial region display unit 203 acquires the width and the height of the display unit 105 of the mobile terminal 100. As illustrated in FIG. 3, the width and the height of the display region on the display unit 105 of the mobile terminal 100 are (W00, H00).

In step S902, the partial region display unit 203 determines the attribute contained in the partial region record read as the display target in step S801 illustrated in FIG. 8. If the attribute is the text (YES in step S902), the processing proceeds to step S903. If the attribute is the background or a manually specified attribute (NO in step S902), the processing proceeds to step S912.

In step S903, the partial region display unit 203 determines whether the partial region determined to have the text attribute is the itemized list. The itemized list here means character strings with a line head character or symbol, such as a point and a number, placed at the beginning of each character row or column. If the partial region display unit 203 determines that the partial region is not the itemized list (NO in step S903), the processing proceeds to step S904. If the partial region display unit 203 determines that the partial region is the itemized list (YES in step S903), the processing proceeds to step S912.

In step S904, the partial region display unit 203 acquires a writing direction of the text that is contained in the partial region set as the display target. Then, in step S905, the partial region display unit 203 determines the writing direction of the text. If the writing direction of the text is the horizontal writing (YES in step S905), the processing proceeds to step S906. If the writing direction of the text is the vertical writing (NO in step S905), the processing proceeds to step S907.

In step S906, since the writing direction of the text in the partial region is the horizontal writing, the partial region display unit 203 sets the display enlargement ratio of the partial region so that the width contained in the read partial region record will fit in the width of the display unit 105 of the mobile terminal 100. In other words, the partial region display unit 203 determines the display enlargement ratio so as to prevent the direction of the horizontally written text line(s) from extending beyond the display region. For example, in a case where the width contained in the partial region record is W10 and the width of the display unit 105 of the mobile terminal 100 is W00, the display enlargement ratio of the partial region is set to W00/W10 (a quotient calculated by dividing W00 by W10).

In step S907, since the writing direction of the text in the partial region is the vertical writing, the partial region display unit 203 sets the display enlargement ratio of the partial region so that the height contained in the read partial region record will fit in the height of the display unit 105 of the mobile terminal 100. In other words, the partial region display unit 203 determines the display enlargement ratio so as to prevent the direction of the vertically written text line(s) from extending beyond the display region. For example, in a case where the height contained in the partial region record is H10 and the height of the display unit 105 of the mobile terminal 100 is H00, the display enlargement ratio of the partial region is set to H00/H10 (a quotient calculated by dividing H00 by H10).

In step S908, the partial region display unit 203 determines whether the size of the partial region scaled according to the display enlargement ratio set in step S906 or S907 will be larger than the size of the display unit 105 of the mobile terminal 100. In other words, the partial region display unit 203 determines whether a direction perpendicular to the text line(s) in the partial region scaled according to the display enlargement ratio will extend beyond the display unit 105 of the mobile terminal 100. If the partial region display unit 203 determines that the size of the scaled partial region will be larger than the display unit 105 of the mobile terminal 100 and the partial region will be unable to be entirely displayed (YES in step S908), the processing proceeds to step S909. On the other hand, if the size of the scaled partial region will be smaller than the display unit 105 of the mobile terminal 100 and the partial region will be able to be entirely displayed at a time (NO in step S908), the processing proceeds to step S913.

In step S909, the partial region display unit 203 determines the writing direction of the text in the partial region. If the partial region display unit 203 determines that the writing direction of the text is the horizontal writing (YES in step S909), the processing proceeds to step S910. If the partial region display unit 203 determines that the writing direction of the text is the vertical writing (NO in step S909), the processing proceeds to step S911.

In step 910, since the partial region after the scaling will not be contained in the display unit 105, the partial region display unit 203 sets a display position so that a horizontally written first line in the partial region will be displayed on the display unit 150. In the present exemplary embodiment, the partial region display unit 203 determines the coordinates of the display position of the partial region so that an upper left edge of the horizontally written partial region will coincide with the upper left edge of the display unit 105 of the mobile terminal 100.

In step S911, since the partial region after the scaling will not be contained in the display unit 105, the partial region display unit 203 sets the display position so that a vertically written first line in the partial region will be displayed on the display unit 150. In the present exemplary embodiment, the partial region display unit 203 determines the coordinates of the display position of the partial region so that an upper right edge of the vertically written partial region will coincide with the upper right edge of the display unit 105 of the mobile terminal 100.

In step S912, if the attribute is another type than the text (the background, the figure, the table, the manually specified type, or the like), the partial region display unit 203 determines the display enlargement ratio so that both the width and the height of the partial region that are specified in the partial region record will be contained in the size of the display unit 105 of the mobile terminal 100. More specifically, the partial region display unit 203 acquires respective enlargement ratios for the width and the height by comparing the width and the height of the partial region with the width and the height of the display unit 105, and determines to set the enlargement ratio having a smaller value therebetween as the display enlargement ratio. For example, in the case where the width and the height specified in the partial region record are (W10, H10) and the width and the height of the display unit 105 of the mobile terminal 100 are (W00, H00), the partial region display unit 203 compares the width enlargement ratio W00/W10 (the quotient calculated by dividing W00 by W10) and the height enlargement ratio H00/H10 (the quotient calculated by dividing H00 by H10), and determines to set the enlargement ratio having a smaller value therebetween as the display enlargement ratio of the partial region that is the present display target.

In step S913, the partial region display unit 203 determines the coordinates of the display position of the partial region so that a center of the partial region after the scaling will coincide with a center of the display unit 105.

As described above, the partial region display unit 203 determines the display enlargement ratio and the coordinates of the display position for the partial region that is the present display target by performing the processing illustrated in FIG. 9. Then, the processing proceeds to step S804 illustrated in FIG. 8.

### <Display Example of Partial Region Group>

In the following description, a transition example of the screen displayed on the display unit 105 of the mobile terminal 100 by the processing illustrated in FIG. 8 and the processing illustrated in FIG. 9 will be described. In the present example, the screen transition will be described assuming that the example of the first page in the partial region management table illustrated in FIG. 7 is read, with reference to FIGS. 10A to 10F. In FIGS. 10A to 10F, the screen of the mobile terminal 100 transitions in an order of FIGS. 10A to 10F.

In step S801, the partial region display unit 203 reads the partial region record ID01, which corresponds to the first place in the display order of the first page, from the partial region management table illustrated in FIG. 7. In step S803, the partial region display unit 203 performs the display range determination processing for the partial region. Since the attribute of the partial region record identified by ID01 is the background, in step S912, the partial region display unit 203 determines the display enlargement ratio so that the entire partial region will be contained in the display unit 105 of the mobile terminal 100. Further, in step S913, the partial region display unit 203 determines the coordinates of the display position of the partial region so that the center of the partial region will coincide with the center of the display unit 105 of the mobile terminal 100. Then, in step S804, the partial region display unit 203 displays the partial region identified by ID01, which is the present display target, on the display unit 105 of the mobile terminal 100 according to the determined display enlargement ratio and the coordinates of the display position. FIG. 10A illustrates a display state at this time.

If the next button 301 is tapped by the user in the display state illustrated in FIG. 10A (YES in step S805), in step S801, the partial region display unit 203 reads the partial region record identified by the identifier ID02, which is provided with the display order (2) next to the display order (1) of the identifier ID01, from the partial region management table illustrated in FIG. 7. Since the attribute of the partial region record identified by ID02 is the text and the horizontal writing, in step S906, the partial region display unit 203 determines the display enlargement ratio so that the width of the partial region will be contained in the width of the display unit 105 of the mobile terminal 100. Because the width and the height of the partial region identified by the identifier ID02 after the scaling at this determined display enlargement ratio will be smaller than the width and the height of the display unit 105 of the mobile terminal 100, in step S913, the partial region display unit 203 determines the coordinates of the display position of the partial region so that the center of the partial region will coincide with the center of the display unit 105 of the mobile terminal 100. Then, in step S804, the partial region display unit 203 displays the partial region identified by ID02, which is the present display target, on the display unit 105 of the mobile terminal 100 according to the determined display enlargement ratio and the coordinates of the display position. FIG. 10B illustrates a display state at this time.

If the next button 301 is tapped by the user in the display state illustrated in FIG. 10B (YES in step S805), in step S801, the partial region display unit 203 reads the partial region record identified by the identifier ID03, which is provided with the display order (3) next to the display order (2) of the identifier ID02, from the partial region management table illustrated in FIG. 7. Since the attribute of the partial region record identified by ID03 is the text and the horizontal writing, in step S906, the partial region display unit 203 determines the display enlargement ratio so that the width of the partial region will be contained in the width of the display unit 105 of the mobile terminal 100. Because the width and the height of the partial region identified by the identifier ID03 after the scaling at this determined display enlargement ratio will be smaller than the width and the height of the display unit 105 of the mobile terminal 100, in step 913, the partial region display unit 203 determines the coordinates of the display position of the partial region so that the center of the partial region will coincide with the center of the display unit 105 of the mobile terminal 100. Then, in step S804, the partial region display unit 203 displays the partial region identified by ID03, which is the present display target, on the display unit 105 of the mobile terminal 100 according to these determined display enlargement ratio and coordinates of the display position. FIG. 10C illustrates a display state at this time.

If the next button 301 is tapped by the user in the display state illustrated in FIG. 10C (YES in step S805), in step S801, the partial region display unit 203 reads the partial region record identified by the identifier ID04, which is provided with the display order (4) next to the display order (3) of the identifier ID03, from the partial region management table illustrated in FIG. 7. Since the attribute of the partial region record identified by ID04 is the figure, in step S912, the partial region display unit 203 determines the display enlargement ratio so that the entire partial region will be contained in the display unit 105 of the mobile terminal 100. The partial region display unit 203 determines the coordinates of the partial region so that the center of the partial region identified by the identifier ID04 after the scaling at this determined display enlargement ratio will coincide with the center of the display unit 105 of the mobile terminal 100. Then, in step S804, the partial region display unit 203 displays the partial region identified by ID 04, which is the present display target, on the display unit 105 of the mobile terminal 100 according to these determined display enlargement ratio and coordinates of the display position. FIG. 10D illustrates a display state at this time.

If the next button 301 is tapped by the user in the display state illustrated in FIG. 10D (YES in step S805), in step S801, the partial region display unit 203 reads the partial region record identified by the identifier ID05, which is provided with the display order (5) next to the display order (4) of the identifier ID04, from the partial region management table illustrated in FIG. 7. Since the attribute of the partial region record identified by ID05 is the photograph, in step S912, the partial region display unit 203 determines the display enlargement ratio so that the entire partial region will be contained in the display unit 105 of the mobile terminal 100. The partial region display unit 203 determines the coordinates of the partial region so that the center of the partial region identified by the identifier ID05 after the scaling at this determined display enlargement ratio will coincide with the center of the display unit 105 of the mobile terminal 100. Then, in step S804, the partial region display unit 203 displays the partial region identified by ID05, which is the present display target, on the display unit 105 of the mobile terminal 100 according to the determined display enlargement ratio and the coordinates of the display position. FIG. 10E illustrates a display state at this time.

If the next button 301 is tapped by the user in the display state illustrated in FIG. 10E (YES in step S805), in step S801, the partial region display unit 203 reads the partial region record identified by the identifier ID06, which is provided with the display order (6) next to the display order (5) of the identifier ID05, from the partial region management table illustrated in FIG. 7. Since the attribute of the partial region record identified by ID06 is the text (the itemized list), in step S912, the partial region display unit 203 determines the display enlargement ratio so that the entire partial region will be contained in the display unit 105 of the mobile terminal 100. The partial region display unit 203 determines the coordinates of the partial region so that the center of the partial region identified by the identifier ID06 after the scaling at this determined display enlargement ratio will coincide with the center of the display unit 105 of the mobile terminal 100. Then, in step S804, the partial region display unit 203 displays the partial region identified by ID06, which is the present display target, on the display unit 105 of the mobile terminal 100 according to the determined display enlargement ratio and the coordinates of the display position. FIG. 10F illustrates a display state at this time.

The execution of the above-described processing allows the partial regions to be recognized according to the document components such as the text and the image in the page image, and the partial regions to be displayed sequentially at the respective display enlargement ratios set for each of the partial regions with the simple operation.

In the present exemplary embodiment, while the above-described partial region display unit 203 is in the middle of displaying the entire page image or the partial region, the marker drawing unit 205 performs the marker drawing processing based on a user's instruction, which is further followed by the enlarged display processing for the region where this marker is drawn. In the following description, these processing procedures will be described.

### <Marker Drawing Processing>

The marker drawing unit 205 and the marker region processing unit 206 perform the marker drawing processing according to the procedure illustrated in FIG. 11. The marker drawing processing is included in the image display program stored in the ROM 103, and is performed by the CPU 101.

In step S1101, the marker drawing unit 205 determines a flag indicating whether the marker drawing mode is enabled, which is stored in the storage area such as the RAM 102. The marker drawing mode is switched to be enabled/disabled according to the tap performed on the marker button 303. If the marker drawing mode is enabled (YES in step S1101), the processing proceeds to step S1102. If the marker drawing mode is not enabled (NO in step S1101), the processing proceeds to step S1112.

In step S1102, the marker drawing unit 205 draws the marker on the image of the partial region currently displayed on the display unit 105 based on the coordinate position contained in the drag event received from the operation control unit 204 according to the drag operation performed by the user. This means that, when the user drags the user's fingertip on a position where the user wants to draw a marker shaped as desired, the marker is drawn on this position by this operation.

In step S1103, the marker drawing unit 205 determines whether the drag event that the marker drawing unit 205 is notified of from the operation control unit 204 is ended. If this event is not ended (NO in step S1103), the processing returns to step S1102. Then, the marker drawing unit 205 continues drawing the marker. If this event is ended (YES in step S1103), the marker drawing unit 205 passes the processing to the marker region processing unit 206. Then, the processing proceeds to step S1104.

In step S1104, the marker region processing unit 206 acquires an upper limit value for a marker display time, which is stored in the storage area such as the RAM 102. The upper limit value for the marker display time is an upper limit of a time during which the drawn marker is continuously displayed, and is set to, for example, 10.0 seconds. The marker in the present exemplary embodiment is assumed to be drawn as a temporarily displayed emphasizing marker, and is arranged to be automatically deleted after being displayed for a certain time. Therefore, this upper limit value is used to realize processing for gradually fading the marker and deleting the marker in the end after displaying the drawn marker for the certain time. Then, the processing proceeds to step S1105.

In step S1105, the marker drawing unit 205 starts measuring a display time of the drawn marker. Then, the processing proceeds to step S1106.

In step S1106, the marker region processing unit 206 determines whether the tap event on the next button 301, the previous button 302, or the marker button 303 is received from the operation control unit 204. If the event on any of these buttons 301, 302, and 303 is received (YES in step S1106), the processing proceeds to step S1111. If the event on any of these buttons 301, 302, and 303 is not received (NO in step S1106), the processing proceeds to step S1107.

In step S1107, the marker region processing unit 206 determines whether the measured marker display time exceeds the upper limit value acquired in step S1104. If the marker region processing unit 206 determines that the marker display time exceeds the upper limit value (YES in step S1107), the processing proceeds to step S1108. If the marker display time does not exceed the upper limit value (NO in step S1107), the processing returns to step S1106.

In step S1108, the marker region processing unit 206 acquires a transition time to be used for ending the marker region from the storage area such as the RAM 102. The transition time to be used for ending the marker region is a time taken to perform the processing for gradually fading a color of the drawn marker without immediately deleting the marker that is an deleting target. Then, the processing proceeds to step S1109.

In step S1109, the marker region processing unit 206 takes the transition time for ending the marker region, which has been acquired in step S1108, to gradually fade the color of the marker, and deletes the marker after the transition time has elapsed. The marker region processing unit 206 completes the marker drawing processing after deleting the marker.

In step S1111, the marker region processing unit 206 immediately deletes the drawn marker. This is because, if the next button 301 or the previous button 302 is tapped, the screen transitions to a display of another partial region, and the drawn marker becomes unnecessary. Further, if the marker button 303 is tapped, the marker drawing is disabled, whereby the marker region processing unit 206 also immediately deletes the marker.

In step S1112, the marker region processing unit 206 passes the processing to the partial region display unit 203, and the partial region display unit 203 continues the normal display processing for the partial region group, which is illustrated in FIG. 8.

### <Drawing Example of Marker>

An example of a screen transition on the display unit 105 of the mobile terminal 100 during the execution of the marker drawing processing, which is illustrated in FIG. 11, will be described with reference to FIGS. 12A to 12D. In FIGS. 12A to 12D, the screen of the mobile terminal 100 transitions in an order of FIGS. 12A to 12D. In the present example, the screen transition will be described assuming that the marker button 303 is tapped and the marker drawing mode is enabled, and then the marker drawing processing is performed, in the display state illustrated in FIG. 10D, by way of example.

FIG. 12A illustrates a state in which the tap on the marker button 303 is received from the user onto the display unit 105 of the mobile terminal 100 in the display state illustrated in FIG. 10D. When the tap on the marker button 303 is received (1201), in step S1101, the color of the button 303 is changed to indicate that the marker drawing mode is enabled. The marker button 303 is the toggle switch, as described with reference to FIG. 3. If the marker button 330 is tapped when the marker drawing mode is in the disabled state, the marker drawing mode is enabled. On the other hand, if the marker button 330 is tapped when the marker drawing mode is in the enabled state, the marker drawing mode is disabled.

FIG. 12B illustrates a state in which, in step S1102, the drag operation is received from the user onto the display unit 105 of the mobile terminal 100 (1202) and the marker drawing unit 205 draws the marker in the display state illustrated in FIG. 12A. This example is such an example that the drag operation is received as an operation of dragging the finger as if elliptically circling a part of a displayed pie graph (1202), and the marker is drawn according to coordinates of this operation. The marker region processing unit 206 maintains this display state until the marker display time exceeds the upper limit value.

FIG. 12C illustrates a state during the transition time, in which, in steps S1108 and S1109, the marker region processing unit 206 is performing the processing for gradually fading the marker region after the marker display time exceeds the upper limit value from the display state illustrated in FIG. 12B. This state is a state after an elapse of approximately a half of the set transition time to be used for ending the marker.

FIG. 12D illustrates a state in which the transition time has elapsed, and the deletion of the drawn marker is carried out and this marker is deleted from the display state illustrated in FIG. 12C.

### <Marker Region Specification Processing>

The marker region processing unit 206 specifies a region containing the marker drawn by the marker drawing processing (FIG. 11) that is performed by the marker drawing unit 205, and determines an enlarged display position according to the procedure illustrated in FIG. 13. The processing procedure of the marker region specification processing, which is illustrated in FIG. 13, is included in the image display program stored in the ROM 103, and is performed by the CPU 101.

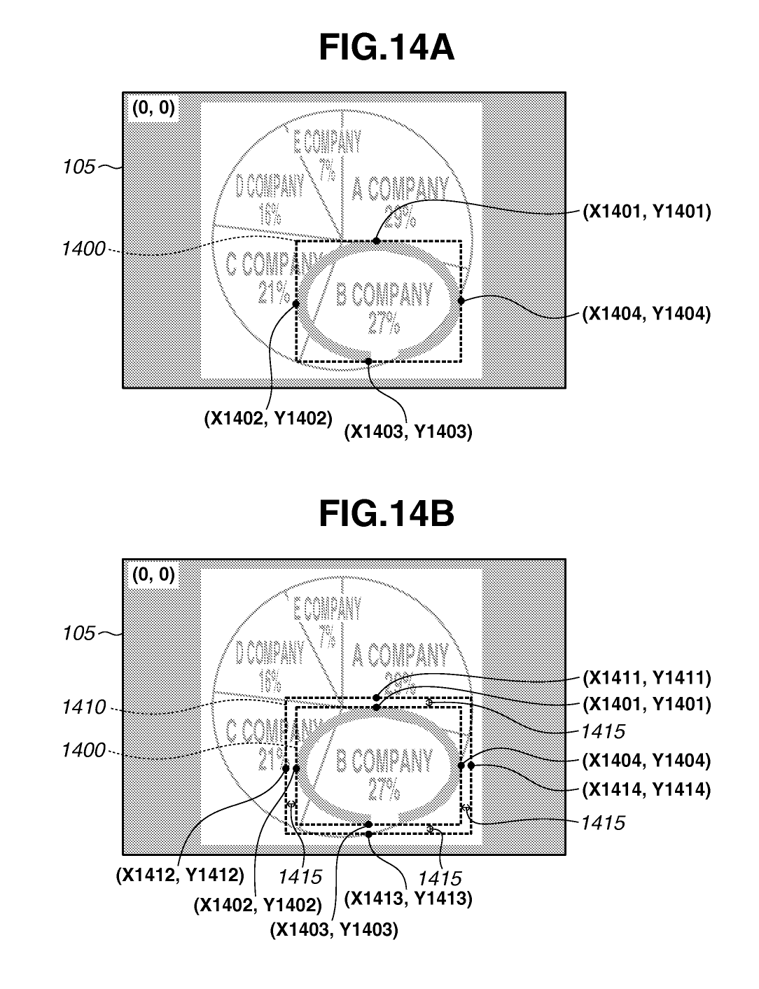

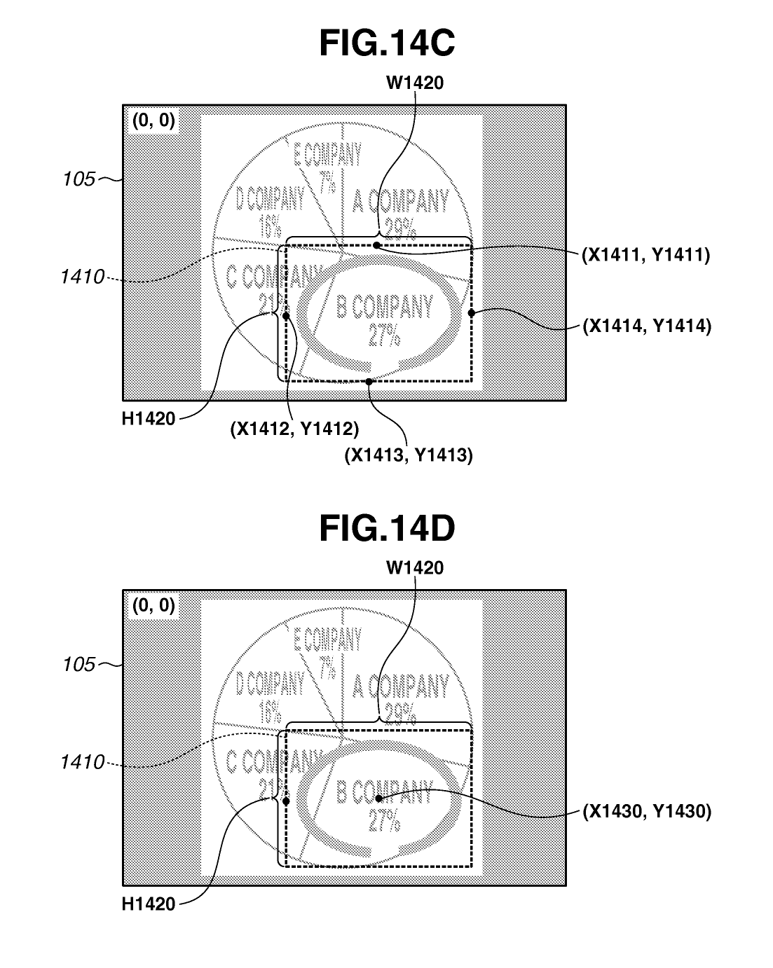

An example of the marker region specification processing will be described with reference to FIGS. 14A to 14D. A marker set as a processing target is the same marker as the marker drawn in FIG. 12B, and is the marker drawn as if a part of the displayed graph is elliptically circled. In FIGS. 14A to 14D, the partial region in the page image is illustrated in a faint color to make a description of the marker region specification processing easily understandable.

In step S1301, the marker region processing unit 206 acquires respective coordinates of an upper edge, a lower edge, a left edge, and a right edge of the marker drawn by the marker drawing processing, which is illustrated in FIG. 11. In FIGS. 14A to 14D, assume that the coordinates of the upper edge, the left edge, the lower edge, and the right edge are (X1401, Y1401), (X1402, Y1402), (X1403, Y1403), and (X1404, Y1404), respectively. FIG. 14A illustrates these coordinates.

In step S1302, the marker region processing unit 206 specifies a rectangular region 1400 containing the coordinates of the four points acquired in step S1301. As illustrated in FIG. 14A, the marker region processing unit 206 specifies the rectangular region 1400 so that this region contains the coordinates of the upper edge acquired in step S1301 on a top side thereof, the coordinates of the lower edge acquired in step S1301 on a bottom side thereof, the coordinates of the left edge acquired in step S1301 on a left side thereof, and the coordinates of the right edge acquired in step S1301 on a right side thereof. Then, the processing proceeds to step S1303.

In step S1303, the marker region processing unit 206 updates the rectangular region 1400 by vertically and horizontally adding a margin 1415 to the rectangular region 1400 specified in the previous step, and sets an updated rectangular region 1410 as the marker region. FIG. 14B illustrates the thus-set marker region 1410.

In FIG. 14B, the respective coordinates after the addition of the margin 1415 are updated in the following manner. The coordinates of the upper edge are (X1411, Y1411)=(X1401, Y1401−1415). The coordinates of the left edge are (X1412, Y1412)=(X1402−1415, Y1402). The coordinates of the lower edge are (X1413, Y1413)=(X1403, Y1403+1415). The coordinates of the right edge are (X1414, Y1414)=(X1404+1415, Y1404). The rectangular region containing these coordinates on the respective sides is set as the marker region 1410. Then, the marker region processing unit 206 calculates a width and a height of the marker region 1410. Assuming that the width and the height of the marker region 1410 are W1420 and H1420, respectively, the width W1420 is calculated as the width W1420=(X1404+1415)−(X1402−1415)=(X1404−X1402+2×1415), and the height H1420 is calculated as the height H1420=(Y1403+1415)−(Y1401−1415)=(Y1403−Y1401+2×1415). FIG. 14C illustrates these width W1420 and height H1420.

The above-described margin 1415 is added to improve visibility of the drawn marker when the marker region 1410 is displayed in an enlarged manner. After the marker region processing unit 206 specifies the marker region 1410 containing the margin 1415, the processing proceeds to step S1304.

In step S1304, the marker region processing unit 206 acquires the width and the height of the display unit 105 of the mobile terminal 100. Then, the processing proceeds to step S1305. As illustrated in FIG. 3, the width and the height of the display unit 105 of the mobile terminal 100 are (W00, H00).

In step S1305, the marker region processing unit 206 determines the display enlargement ratio so that the marker region 1410 specified in step S1303 will be entirely contained in the display unit 105 of the mobile terminal 100. For this purpose, the marker region processing unit 206 compares the width and the height of the marker region 1410 with the width and the height of the display unit 105 to acquire the respective enlargement ratios in the width direction and the height direction, and determines to set the enlargement ratio having a smaller value therebetween as the display enlargement ratio. For example, in the case where the width and the height of the marker region 1410 are (W1420, H1420) and the width and the height of the display unit 105 of the mobile terminal 100 are (W00, H00), the marker region processing unit 206 compares a width enlargement ratio W00/W1420 (a quotient calculated by dividing W00 by W1420) and a height enlargement ratio H00/H1420 (a quotient calculated by dividing H00 by H1420), and determines a smaller value therebetween as the display enlargement ratio. After the marker region processing unit 206 specifies the display enlargement ratio of the marker region 1410, the processing proceeds to step S1306.

In step S1306, the marker region processing unit 206 calculates central coordinates (X1430, Y1430) of the marker region 1410. FIG. 14D illustrates the central coordinates of the marker region 1410. The central coordinates are calculated as (X1430, Y1430)=(((X1412+X1414)/2), ((Y1411+Y1413)/2)). Displaying the marker region 1410 in such a manner that these central coordinates coincide with the center of the display unit 105 when displaying the marker region 1410 in an enlarged manner results in a display of the marker region 1410 in the middle of the display unit 105.

The marker region processing unit 206 specifies the marker region, and determines the display enlargement ratio and the central coordinates of the marker region by performing the above-described processing illustrated in FIG. 13. Next, an example of a method for displaying the thus-specified marker region in the enlarged manner, and an example of a screen transition at this time will be described with reference to FIGS. 15, and 16A to 16G.

### <Enlarged Display Processing for Maker Region and Ending Processing for the Enlarged Display>

The marker drawing unit 205 and the marker region processing unit 206 perform the enlarged display processing for the marker region according to the procedure illustrated in FIG. 15, in addition to the marker drawing processing, which has been described with reference to FIG. 13. The enlarged display processing for the marker region is included in the image display program stored in the ROM 103, and is performed by the CPU 101.

In step S1501, the marker drawing unit 205 determines the flag indicating whether the marker drawing mode is enabled, which is stored in the storage area such as the RAM 102. If the marker drawing mode is enabled (YES in step S1501), the processing proceeds to step S1502. If the marker drawing mode is not enabled (NO in step S1501), the processing proceeds to step S1532.

In step S1502, the marker drawing unit 205 draws the marker on the image of the partial region currently displayed on the display unit 105 based on the coordinate position contained in the drag event received from the operation control unit 204. In other words, when the user drags the user's fingertip on a position where the user wants to draw a marker shaped as desired, the marker is drawn on this position by this operation.

In step S1503, the marker drawing unit 205 determines whether the drag event that the marker drawing unit 205 is notified of from the operation control unit 204 is ended. If this event is not ended (NO in step S1503), the processing returns to step S1502. Then, the marker drawing unit 205 continues drawing the marker. If this event is ended (YES in step S1503), the marker drawing unit 205 passes the processing to the marker region processing unit 206. Then, the processing proceeds to step S1504.

In step S1504, the marker region processing unit 206 acquires the upper limit value for the marker display time, which is stored in the storage area such as the RAM 102. The upper limit value for the marker display time is the upper limit of the time during which the drawn marker is continuously displayed, and is set to, for example, 10.0 seconds. The marker in the present exemplary embodiment is assumed to be drawn as the temporarily displayed emphasizing marker, and is arranged to be automatically deleted after being displayed for the certain time. Therefore, this upper limit value is used to realize the processing for gradually fading the marker and deleting the marker in the end after displaying the drawn marker for the certain time.

In step S1505, the marker drawing unit 205 starts measuring a display time for the drawn marker.

In step S1506, the marker region processing unit 206 determines whether the double tap event is received from the operation control unit 204. The marker region processing unit 206 processes the double tap event after the marker is drawn as a marker region enlargement display instruction. The double tap is one example as the marker region enlargement display instruction, and another gesture operation may be used therefor. If the marker region processing unit 206 determines that the marker region enlargement display instruction is issued (YES in step S1506), the processing proceeds to step S1507. If the marker region processing unit 206 determines that the double tap event is not received (i.e., the marker region enlargement display instruction is not issued) (NO in step S1506), the processing proceeds to step S1521.

In step S1507, the marker region processing unit 206 performs the marker region specification processing, which has been described with reference to FIG. 13. More specifically, the marker region processing unit 206 performs the processing for specifying the rectangular region containing the region where the marker is drawn, and specifying the display enlargement ratio, the central coordinates, and the range thereof.

In step S1508, the marker region processing unit 206 stores the display enlargement ratio and the coordinates of the currently displayed partial region before performing the enlarged display processing for the marker region.

In step S1509, the marker region processing unit 206 acquires a transition time to be used for the marker region enlarged display processing (for example, one second), which is stored in the storage area such as the RAM 102. Then, the processing proceeds to step S1510.

In step S1510, the marker region processing unit 206 takes the transition time acquired in step S1509 to gradually enlarge the marker region to the enlarged display so that the marker region acquired in the marker region specification processing in step S1507 is displayed in the enlarged manner on the screen. At this time, such a transition can be achieved by gradually changing the enlargement ratio from the display enlargement ratio of the currently displayed partial region to the display enlargement ratio of the marker region that has been determined in step S1305 in the marker region specification processing, which is illustrated in FIG. 13, and at the same time, gradually displacing the display position so that the central coordinates of the marker region that have been determined in step S1306 coincide with the center of the display unit 105.

In step S1511, the marker region processing unit 206 resets the marker display time, and starts measuring the marker display time again.

In step S1512, the marker region processing unit 206 determines whether the tap event on the next button 301, the previous button 302, or the marker button 303 is received from the operation control unit 204 while the enlarged display for the marker region is performed. If the marker region processing unit 206 determines that the tap event on any of these buttons 301 to 303 is received (YES in step S1512), the processing proceeds to step S1531. On the other hand, if the marker region processing unit 206 determines that the tap event on any of these buttons 301 to 303 is not received (NO in step S1512), the processing proceeds to step S1513.

In step S1513, the marker region processing unit 206 determines whether the tap event on the marker region is received from the operation control unit 204 while the enlarged display for the marker region is performed. If the marker region processing unit 206 determines that the tap event on the marker region is received (YES in step S1513), the marker region processing unit 206 processes the tap event on the marker region as an instruction to extend the enlarged display time for the marker region. If the marker region processing unit 206 determines that the instruction to extend the enlarged display time for the marker region is received (YES in step S1513), the processing returns to step S1511. Then, the marker region processing unit 206 starts measuring the marker display time again. In other words, the user can extend the enlarged display time for the marker region, by tapping the marker region while the enlarged display for the marker region is performed. If the tap event on the marker region is not received by the marker region processing unit 206 (NO in step S1513), the processing proceeds to step S1514.

In step S1514, the marker region processing unit 206 determines whether the double tap event is received from the operation control unit 204 after the enlarged display for the marker region is performed. If the double tap event is received (YES in step S1514), the processing proceeds to step S1518. Then, the marker region processing unit 206 processes the double tap event as an instruction to end the enlarged display of this marker region. The double tap is one example as the instruction to end the marker region enlarged display processing, and another gesture may be used therefor. If the instruction to end the marker region enlarged display processing is received (YES in step S1514), the processing proceeds to step S1518. Then, the marker region processing unit 206 acquires a transition time to use when the marker region enlarged display is ended. If the instruction to end the enlarged display is not received (NO in step S1514), the processing proceeds to step S1515.

In step S1515, the marker region processing unit 206 determines whether the marker display time exceeds the upper limit value acquired in step S1504. If the marker display time exceeds the upper limit value (YES in step S1515), the processing proceeds to step S1516. Then, the marker region processing unit 206 acquires a transition time to use when the marker region enlarged display is ended. If the marker display time does not exceed the upper limit value (NO in step S1515), the processing returns to step S1512.

In step S1516, the marker region processing unit 206 acquires a transition time A to be used for ending the marker region, which is stored in the storage area such as the RAM 102. The transition time A to be used for ending the marker region is, for example, 5.0 seconds.

In step S1518, the marker region processing unit 206 acquires a transition time B to be used for ending the marker region, which is stored in the storage area such as the RAM 102. The transition time B to be used for ending the marker region is, for example, 2.5 seconds.

In step S1517, the marker region processing unit 206 takes the transition time A or B to be used for ending the marker region, which has been acquired in step S1516 or S1518, to gradually fade the marker, and at the same time, gradually change the size of this region to the display size of the original partial region according to the original display enlargement ratio and coordinates saved in step S1508. After the transition time A or B has elapsed, the gradually faded marker is deleted in the end.

Regarding the transition time in the ending processing for the marker region enlarged display processing, different values can be set as a value of the transition time A to be used for ending the marker region, which is acquired in step S1516 if the marker display time reaches the upper limit value (YES in step S1515), and a value of the transition time B to be used for ending the marker region, which is acquired in step S1518 if the double tap is received (YES in step S1514). Setting the different values allows the time taken for the screen transition in the ending processing for the marker region enlarged display processing to be switched between when the double tap is received and when the marker display time exceeds the upper limit value without the operation received after the enlarged display for the marker region is performed. For example, in the case where the transition times A and B are set to the transition time A=5.0 seconds and the transition time B=2.5 seconds, respectively, like the above-described example, the marker region processing unit 206 can perform the ending processing for the marker region enlarged display processing through a faster transition when the double tap is received than the transition when the marker display time reaches the upper limit value.

The user can flexibly control the display time of the enlarged display for the marker region by combining the marker display time and the simple operations, such as the tap operation in step S1513 and the double tap operation in step S1514.

The present exemplary embodiment may be configured in such a manner that, if the tap operation on the marker region is received similarly to step S1513 in the middle of the ending processing for the marker region enlarged display processing in step S1517, the processing returns to step S1510 and the marker region processing unit 206 performs the enlarged display processing for the marker region again.

Upon completing the ending processing for the marker region enlarged display processing and returning the display state to the display position and the display enlargement ratio of the original partial region, the marker region processing unit 206 ends the enlarged display processing for the marker region.

In step S1521, the marker region processing unit 206 determines whether the tap event on the next button 301, the previous button 302, or the marker button 303 is received from the operation control unit 204 after the marker is drawn. If the marker region processing unit 206 determines that the tap event on any of these buttons 301 to 303 is received (YES in step S1521), the processing proceeds to step S1531. On the other hand, if the tap event on any of these buttons 301 to 303 is not received (NO in step S1521), the processing proceeds to step S1522.

In step S1522, the marker region processing unit 206 determines whether the tap event on another display region than the next button 301, the previous button 302, and the marker button 303 is received from the operation control unit 204 after the marker is drawn. If this tap event is received (YES in step S1522), the marker region processing unit 206 processes the tap event on the other display region than the buttons 301 to 303 as an instruction to extend the time during which the drawn marker is displayed. If the instruction to extend the display time of the drawn marker is received by the marker region processing unit 206 (YES in step S1522), the processing returns to step S1505. Then, the marker drawing unit 205 starts measuring the marker display time again. In other words, the user can extend the display time of the drawn marker, by tapping another display region than the buttons 301 to 303 after the marker is drawn. If the tap event on another display region than the buttons 301 to 303 is not received by the marker region processing unit 206 (NO in step S1522), the processing proceeds to step S1523.

In step S1523, the marker region processing unit 206 determines whether the marker display time exceeds the upper limit value acquired in step S1504. If the marker display time exceeds the upper limit value (YES in step S1523), the processing proceeds to step S1524. Then, the marker region processing unit 206 acquires the transition time A to use when ending the marker region. On the other hand, if the marker display time does not exceed the upper limit value (NO in step S1523), the processing returns to step S1521.

In step S1524, the marker region processing unit 206 acquires the transition time A to be used for ending the marker region, which is stored in the storage area such as the RAM 102. The transition time A to be used for ending the marker region is, for example, 5.0 seconds.

In step S1525, the marker region processing unit 206 takes the transition time A to be used for ending the marker region, which has been acquired in step S1524, to gradually fade the color of the marker, and deletes this marker after the transition time A has elapsed. If the tap operation is received in the middle of the processing for deleting the drawn marker in step S1525, the processing may return to step S1505 in a similar manner to the processing returning to this step if the tap operation is received in step S1522 (YES in step S1522). Then, the color of the marker may be returned to the original color strength, and the marker display time may be cleared and the measurement thereof may be started again.

In step S1531, the marker region processing unit 206 deletes the drawn marker. At this time, the marker region processing unit 206 immediately deletes the drawn marker, unlike the processing for gradually fading the drawn marker in steps S1517 and S1525. This is because, if the next button 301 or the previous button 302 is tapped, the screen transitions to a display of another partial region, and this marker in the middle of being drawn becomes unnecessary. Further, if the marker button 303 is tapped, the marker drawing is disabled, whereby the marker region processing unit 206 also immediately deletes the marker.

In step S1532, the marker region processing unit 206 passes the processing to the partial region display unit 203, and the partial region display unit 203 continues the normal display processing for the partial region group, which is illustrated in FIG. 8.

### <Example of Screen Transition During Enlarged Display Processing for Marker Region and Ending Processing for Enlarged Display>

A screen transition on the display unit 105 of the mobile terminal 100 during the execution of the marker drawing processing, the enlarged display processing for the marker region, and the ending processing for the enlarged display, which have been described with reference to FIG. 15, will be described with reference to FIGS. 16A to 16G. In the present example, the screen transition will be described assuming that the marker is drawn and an enlarged display of this marker region is performed in the display state illustrated in FIG. 10D, by way of example.

FIG. 16A illustrates a state in which the tap on the marker button 303 is received from the user onto the display unit 105 of the mobile terminal 100 from the display state illustrated in FIG. 10D. When the tap on the marker button 303 is received (1601), in step S1501, the color of the button 303 is changed to indicate that the marker drawing mode is enabled. The marker button 303 is the toggle switch, as described with reference to FIG. 3. If the marker button 303 is tapped when the marker drawing mode is in the disabled state, the marker drawing mode is enabled. On the other hand, if the marker button 303 is tapped when the marker drawing mode is in the enabled state, the marker drawing mode is disabled.

FIG. 16B illustrates a state in which, in step S1502, the drag operation is received from the user onto the display unit 105 of the mobile terminal 100 (1602) and the marker drawing unit 205 draws the marker in the display state illustrated in FIG. 16A. This example is such an example that the drag operation is received as the operation of dragging the finger as if ecliptically circling a part of the displayed pie graph (1602), and the marker is drawn according to coordinates of this operation.

FIG. 16C illustrates a state in which the double tap is received from the display state illustrated in FIG. 16B. As indicated in steps S1506 and S1507 illustrated in FIG. 15, when the double tap event is received from the operation control unit 204 (1603), the marker region processing unit 206 performs the marker region specification processing, which is illustrated in FIGS. 13 and 14A to 14D, thereby specifying the display enlargement ratio, the central coordinates, and the range of the marker region. Further, before displaying the marker region in the enlarged manner, the marker region processing unit 206 stores the display enlargement ratio and the coordinates of the currently displayed partial region. After that, the marker region processing unit 206 takes the set transition time for the enlarged display to display the marker region in the enlarged manner so that the marker region fits to the display unit 105.

FIG. 16D illustrates a state in which the marker region is in the middle of being gradually enlarged to the enlarged display as a result of the reception of the double tap in FIG. 16C. This state is a state after an elapse of approximately a half of the set transition time to the enlarged display. In this state, the process of step S1510 in the display processing for the drawn marker in the enlarged manner, which is illustrated in FIG. 15, is ongoing.

FIG. 16E illustrates a state in which the marker region enlarged display processing is completed from the display state illustrated in FIG. 16D. This state is a result of the completion of the process of step S1510 in the enlarged display processing for the drawn marker, which is illustrated in FIG. 15. After that, the marker region processing unit 206 resets the marker display time and starts measuring the marker display time again, as indicated in step S1511. The marker region processing unit 206 maintains this display state until the marker display time exceeds the upper limit value, but is also capable of clearing the marker display time to prolong the marker region enlarged display processing if the tap operation is received on the marker region, as indicated in step S1513 illustrated in FIG. 15.

The marker region processing unit 206 starts the ending processing for the marker region enlarged display processing after the marker display time exceeds the predetermined time. FIG. 16F illustrates a state in which the enlarged display is in the middle of being gradually ended from the display state illustrated in FIG. 16E. This state is a state after an elapse of approximately a half of the set transition time for the ending the enlarged display, and is a state in which the marker is in the middle of being gradually faded and the enlarged display is also in the middle of being returned to the original size.

FIG. 16G illustrates a state in which the ending processing for the marker region enlarged display processing in step S1517 illustrated in FIG. 15 is completed after the display state illustrated in FIG. 16F.

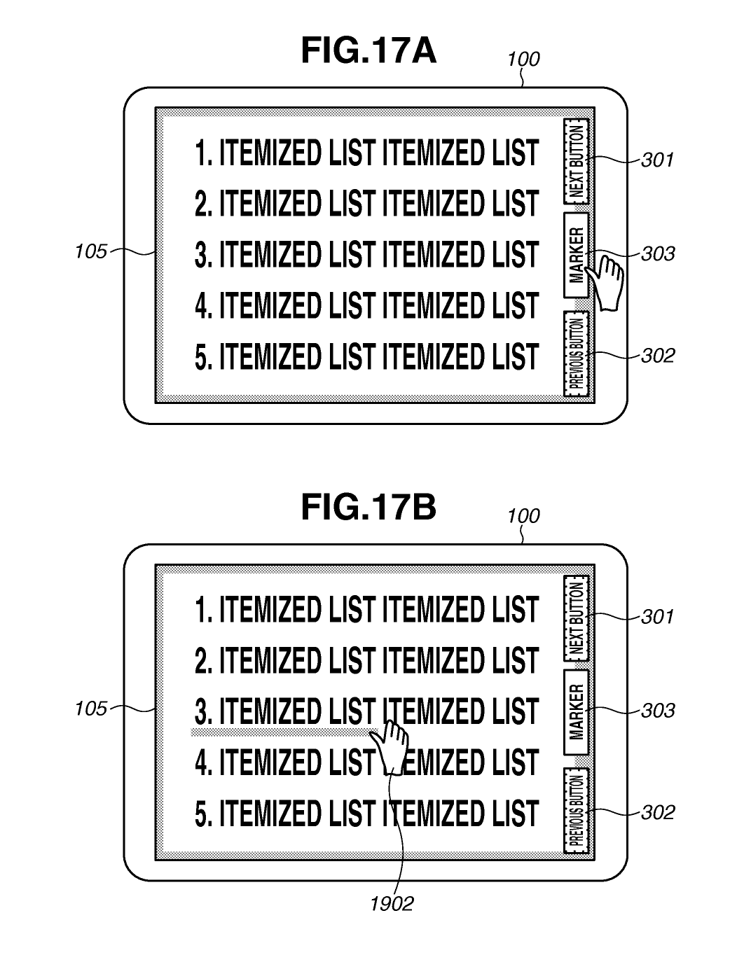

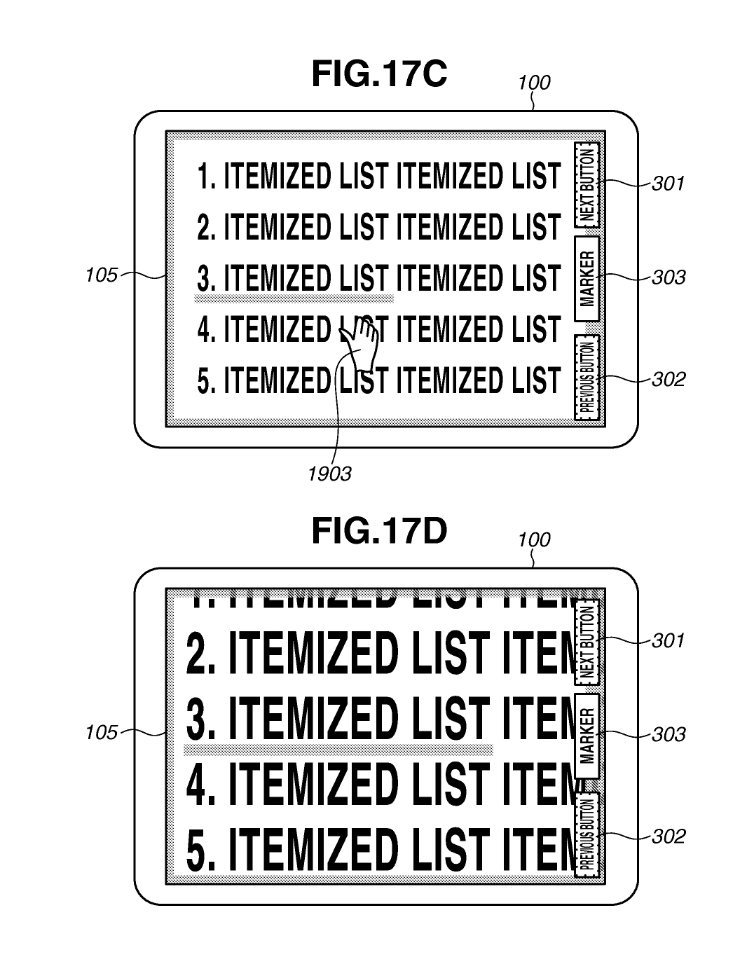

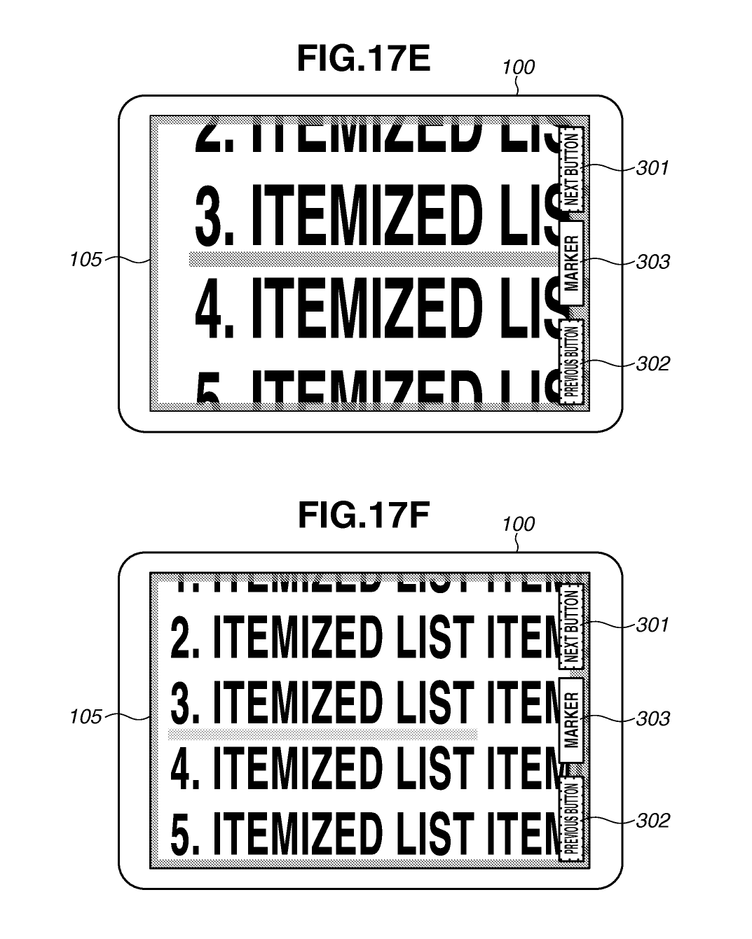

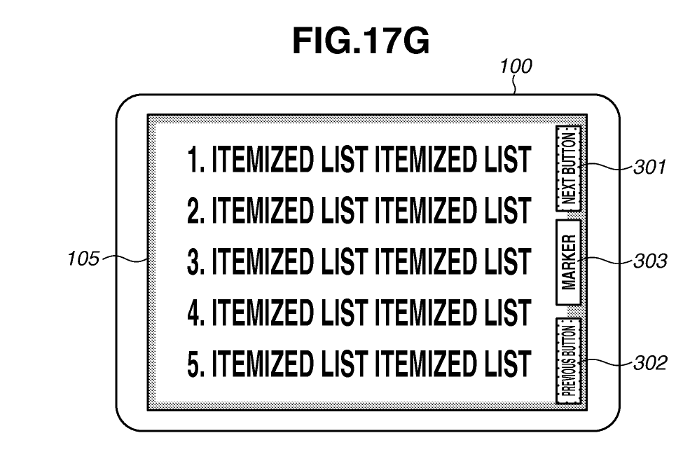

In FIGS. 16A to 16G, the example that draws the marker as if circling the emphasized portion (1602) has been described as an example of the marker drawing. However, the shape of the marker is not limited thereto. For example, the marker may be a marker such as a line or an arrow, or may be a marker shaped as if indicating a character or a symbol. FIGS. 17A to 17G illustrate an example of a screen transition in a case where a linear marker is drawn as if a text in the text region is underlined.

FIG. 17A illustrates a state in which the tap on the marker button 303 is received from the user onto the display unit 105 of the mobile terminal 100 from the display state illustrated in FIG. 10F. When the tap on the marker button 303 is received, the color of the button 303 is changed to indicate that the marker drawing mode is enabled.

FIG. 17B illustrates a state in which the drag operation is received from the user onto the display unit 105 of the mobile terminal 100 and the marker drawing unit 205 draws the marker in the display state illustrated in FIG. 17A. This example is such an example that the drag operation is received as an operation of dragging the finger as if underlining a currently displayed character string, and the marker is drawn according to coordinates of this operation.

FIG. 17C illustrates a state in which the double tap is received from the display state illustrated in FIG. 17B. As indicated in steps S1506 and S1507 illustrated in FIG. 15, when the double tap event is received from the operation control unit 204, the marker region processing unit 206 performs the marker region specification processing, thereby specifying the display enlargement ratio, the central coordinates, and the range of the marker region. Further, before displaying the marker region in the enlarged manner, the marker region processing unit 206 stores the display enlargement ratio and the coordinates of the currently displayed partial region. After that, the marker region processing unit 206 takes the set transition time for the enlarged display to display the marker region in the enlarged manner in such a manner that the marker region fits to the display unit 105.

FIG. 17D illustrates a state in which the marker region is in the middle of being gradually enlarged to the enlarged display as a result of the reception of the double tap in FIG. 17C. This is a state after an elapse of approximately the half of the set transition time for the enlarged display. In this state, the process of step S1510 in the enlarged display processing for the drawn marker, which is illustrated in FIG. 15, is ongoing.

FIG. 17E illustrates a state in which the marker region enlarged display processing is completed from the display state illustrated in FIG. 17D.

The marker region processing unit 206 starts the ending processing for the marker region enlarged display processing after the marker display time exceeds the predetermined time. FIG. 17F illustrates a state in which the enlarged display is in the middle of being gradually ended from the display state illustrated in FIG. 17E. This state is a state after an elapse of approximately the half of the set transition time for ending the enlarged display, and is a state in which the marker is in the middle of being gradually faded and the enlarged display is also in the middle of being returned to the original size.

FIG. 17G illustrates a state after the completion of the ending processing for the marker region enlarged display processing in step S1517 illustrated in FIG. 15 after the display state illustrated in FIG. 17F.

As described above, the present exemplary embodiment allows the marker to be drawn on the portion that the user wants to emphasize, and further the portion where this marker is drawn (the marker region) to be displayed in an enlarged manner with the simple operation such as the double tap, as necessary, when the partial region in the page image is displayed. Further, the present exemplary embodiment allows the display to be returned to the display enlargement ratio of the partial region before the marker region enlarged display processing if the certain time has elapsed or the simple operation by the double tap is received again after the marker region enlarged display processing.

The present exemplary embodiment allows a portion in the page image that is not recognized in advance to be specified impromptu with use of the marker, and further this marker region to be effectively highlighted so that this region leaves a stronger impression on the audience, in the system that displays the page image.

A second exemplary embodiment is different from the first exemplary embodiment in terms of the marker region specification processing. In the present exemplary embodiment, a method that specifies the display enlargement ratio and the display position of the marker region will be described, also taking into consideration the coordinates of the position of the double tap that serves as the enlarged display instruction in addition to the rectangular region containing the drawn marker, in the marker region specification processing. The present exemplary embodiment is similar to the first exemplary embodiment except for the marker region specification processing, and the screen transition during the marker region enlarged display processing and the ending processing for the enlarged display, and therefore a description thereof will be omitted below.

### <Specification Processing for Marker Region>

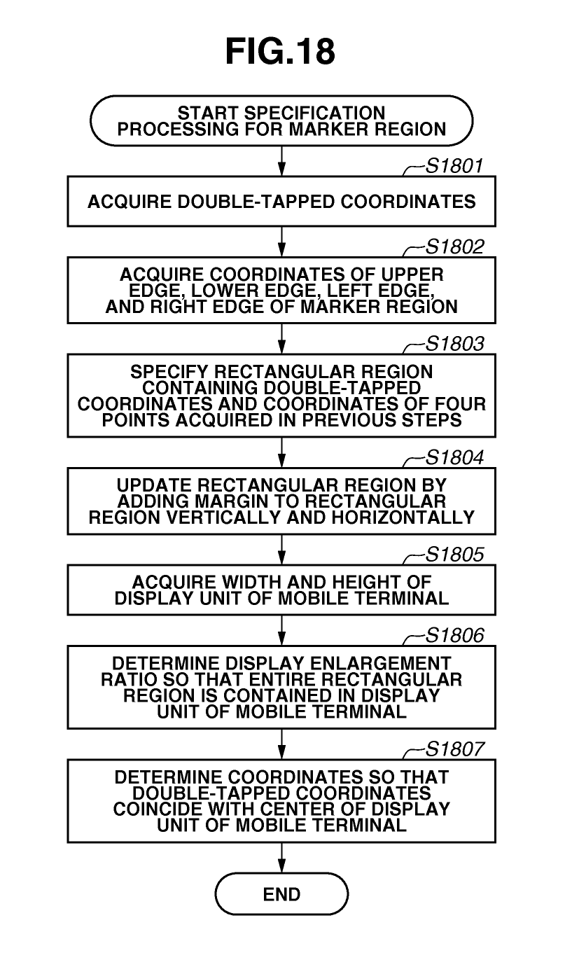

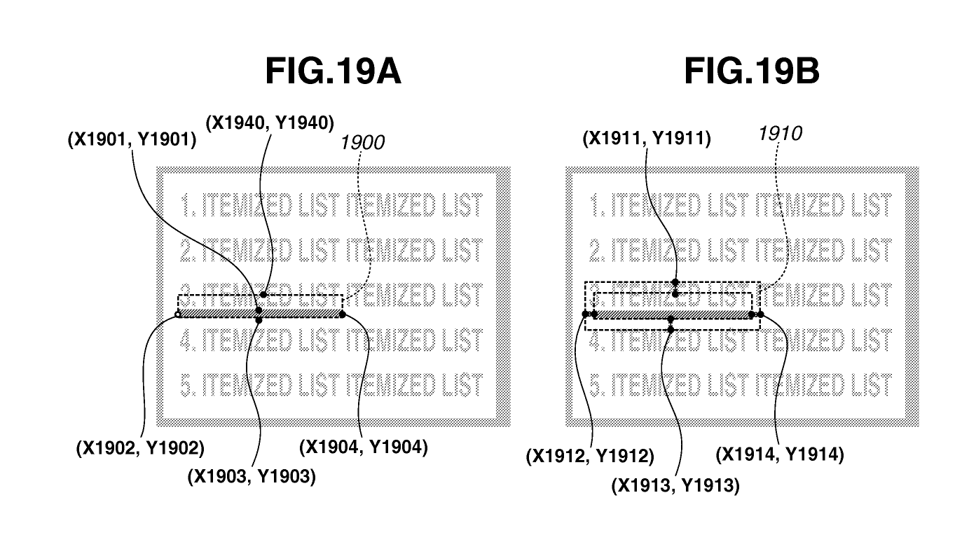

In the second exemplary embodiment, the marker region processing unit 206 performs the marker region specification processing according to a procedure illustrated in FIG. 18. The processing procedure of the marker region specification processing, which is illustrated in FIG. 18, is included in the image display program stored in the ROM 103, and is performed by the CPU 101. In the present exemplary embodiment, the marker region specification processing will be described with reference to FIGS. 19A and 19B as an example thereof. In FIGS. 19A and 19B, the partial region in the page image is illustrated in a faint color for facilitating an understanding of the marker region specification processing.

In step S1801, the marker region processing unit 206 acquires the coordinates of the position double-tapped in step S1506 illustrated in FIG. 15. Assume that the coordinates of this double-tapped position are (X1940, Y1940).

In step S1802, the marker region processing unit 206 acquires respective coordinates of an upper edge, a lower edge, a left edge, and a right edge of the marker drawn by the marker drawing processing, which is illustrated in FIG. 11. In FIGS. 19A and 19B, assume that the coordinates of the upper edge, the left edge, the lower edge, and the right edge are (X1901, Y1901), (X1902, Y1902), (X1903, Y1903), and (X1904, Y1904), respectively.

In step S1803, the marker region processing unit 206 specifies a rectangular region 1900 containing the double-tapped coordinates acquired in step S1801 and the coordinates of the four points of the marker acquired in step S1802. In a case where the double tap is performed on a position slightly above the marker as illustrated in FIG. 19A, the marker region processing unit 206 specifies the rectangular region 1900 so that the rectangular region 1900 contains the coordinates of the double tap acquired in step S1801 on a top side thereof, and the coordinates of the left edge, the lower edge, and the right edge acquired in step S1802 on a left side, a bottom side, and a right side thereof, respectively.

In step S1804, the marker region processing unit 206 updates the rectangular region 1900 by vertically and horizontally adding a margin 1915 to the rectangular region 1900 specified in step S1803, and sets an updated rectangular region 1910 as the marker region. FIG. 19B illustrates the thus-updated rectangular region 1910.

In FIG. 19B, the respective coordinates after the addition of the margin 1915 are updated in the following manner. The coordinates of the upper edge of the rectangular region are (X1911, Y1911)=(X1940, Y1940−1915). The coordinates of the left edge of the rectangular region are (X1912, Y1912)=(X1902−1915, Y1902). The coordinates of the lower edge of the rectangular region are (X1913, Y1913)=(X1903, Y1903+1915). The coordinates of the right edge of the rectangular region are (X1914, Y1914)=(X1904+1915, Y1904). The rectangular region containing these coordinates on the respective sides is set as the marker region 1910. Further, the marker region processing unit 206 calculates a width and a height of the rectangular region 1910 after the update by the addition of the margin 1915. Assuming that the width and the height of the rectangular region 1910 are W1910 and H1910, respectively, the width W1910 is calculated as the width W1910=(X1904−X1902+2×1915), and the height H1910 is calculated as the height H1910=(Y1903−Y1940+2×1915). The above-described margin 1915 is added to improve visibility of the marker region 1910 when the specified marker region 1910 is displayed in an enlarged manner later.

In step S1805, the marker region processing unit 206 acquires the width and the height of the display unit 105 of the mobile terminal 100. Then, the processing proceeds to step S1806. As illustrated in FIG. 3, the width and the height of the display unit 105 of the mobile terminal 100 are (W00, H00).

In step S1806, the marker region processing unit 206 determines the display enlargement ratio so that the rectangular region 1910 specified in step S1804 will be entirely contained in the display unit 105 of the mobile terminal 100. For this purpose, the marker region processing unit 206 acquires respective enlargement ratios of the rectangular region 1910 in the width and height directions, and determines to set the enlargement ratio having a smaller value therebetween as the display enlargement ratio. For example, in the case where the width and the height of the rectangular region 1910 are (W1910, H1910) and the width and the height of the display unit 105 of the mobile terminal 100 are (W00, H00), the marker region processing unit 206 compares a width enlargement ratio W00/W1910 (a quotient calculated by dividing W00 by W1910) and a height enlargement ratio H00/H1910 (a quotient calculated by dividing H00 by H1910), and determines a smaller value therebetween as the display enlargement ratio.

In step S1807, the marker region processing unit 206 determines the double-tapped coordinates acquired in step S1801 as central coordinates based on which the marker region 1910 will be displayed in an enlarged manner. These central coordinates (the coordinates of the position of the double tap) are coordinates for controlling positioning so that these coordinates coincide with the center of the screen when the marker region 1910 is displayed in an enlarged manner.

The marker region processing unit 206 determines the display enlargement ratio and the central coordinates of the marker region 1910, and then ends the marker region specification processing.

### <Example of Screen Transition During Enlarged Display Processing for Marker Region and Ending Processing for Enlarged Display>

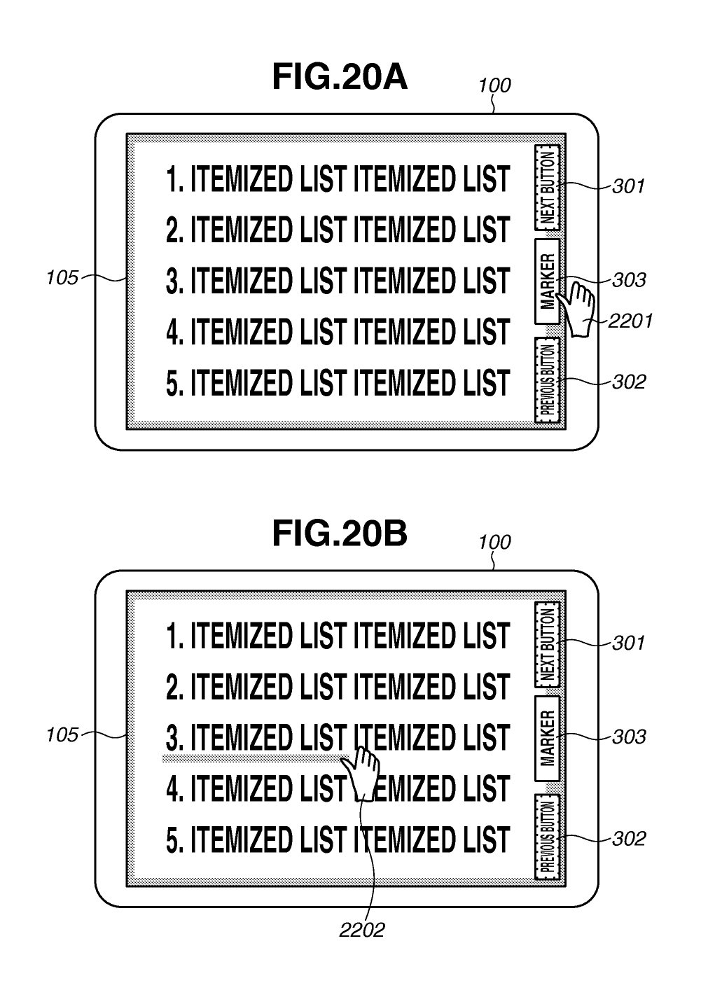

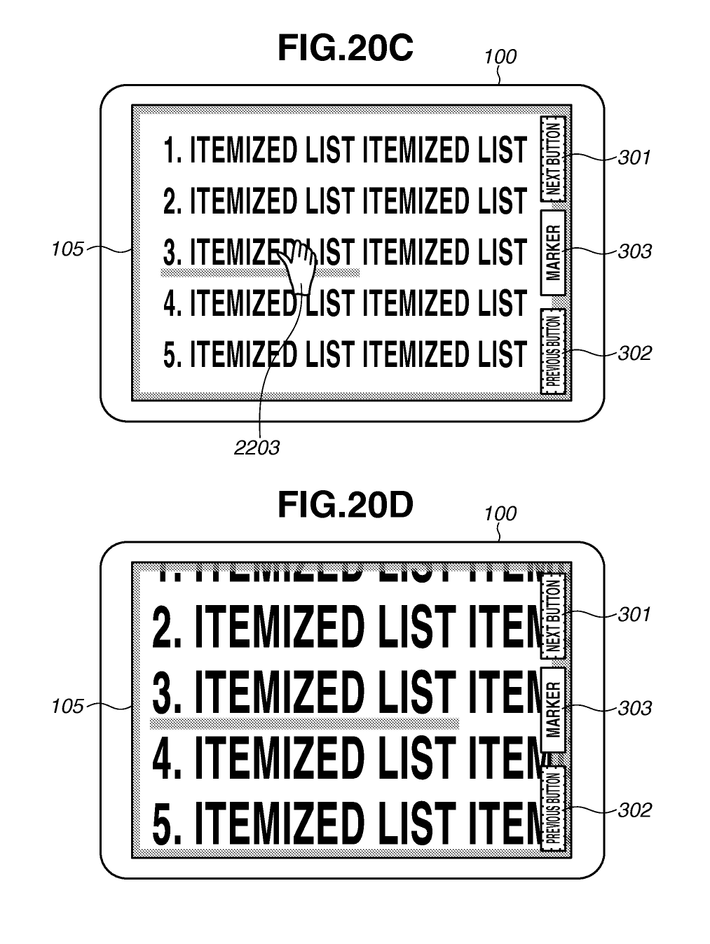

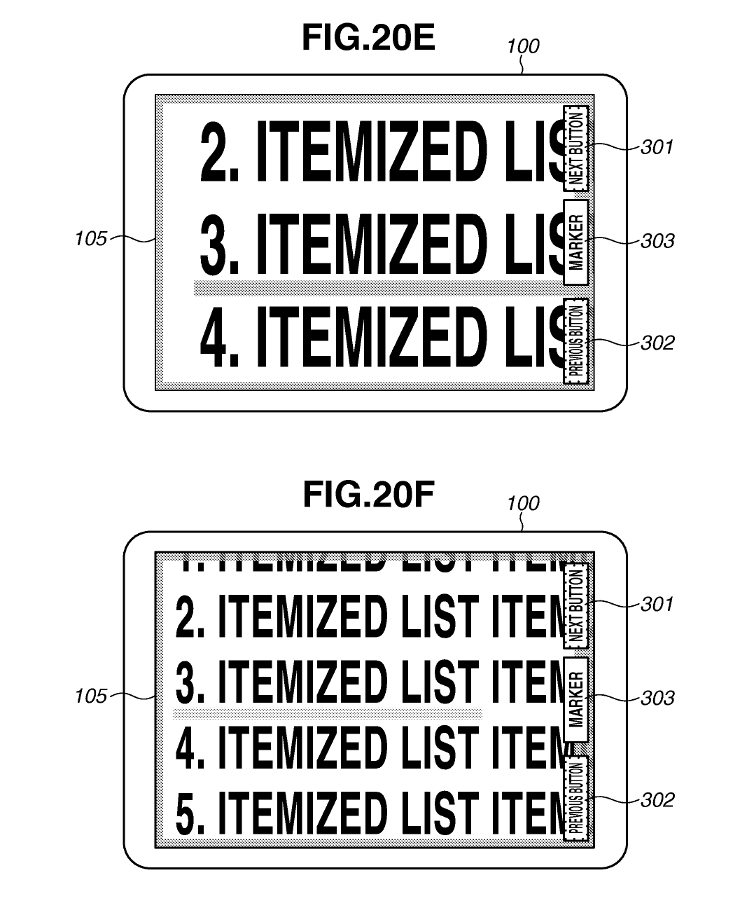

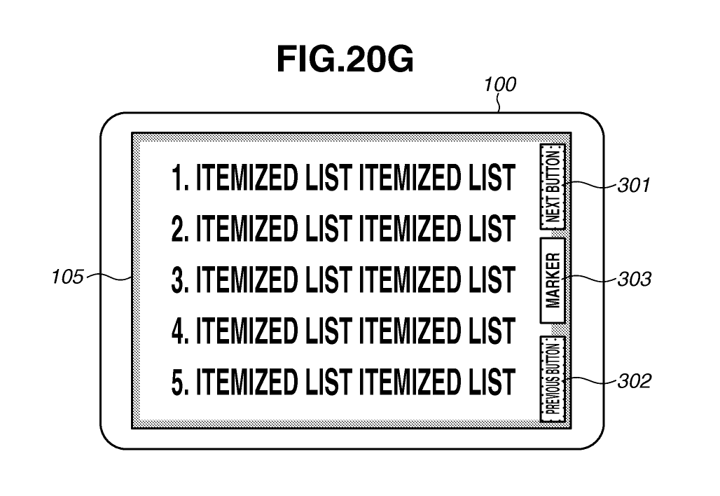

FIGS. 20A to 20G illustrate an example of a screen transition on the display unit 105 of the mobile terminal 100 during execution of the enlarged display processing for the marker region and the ending processing for the enlarged display (FIG. 15) with use of the marker region specification processing, which has been described with reference to FIG. 18. In FIGS. 20A to 20G, the marker is drawn from the display state illustrated in FIG. 10F by way of example, and the screen transitions in an order of FIGS. 20A to 20G when this enlarged display for the marker region is performed.

FIG. 20A illustrates a state in which pressing of the marker button 303 is received from the user onto the display unit 105 of the mobile terminal 100 from the display state illustrated in FIG. 10F. When the tap on the marker button 303 is received (2201), the color of the button 303 is changed to indicate that the marker drawing is enabled.

FIG. 20B illustrates a state in which the drag operation is received from the user onto the display unit 105 of the mobile terminal 100 (2202) and the marker drawing unit 205 draws the marker in the display state illustrated in FIG. 20A. This example is such an example that the drag operation is received as the operation of dragging the finger as if underlining the currently displayed character string, and the marker is drawn according to coordinates of this operation.

FIG. 20C illustrates a state in which the double tap is received from the display state illustrated in FIG. 20B. As indicated in steps S1506 and S1507 illustrated in FIG. 15, when the double tap event is received from the operation control unit 204 (2203), the marker region processing unit 206 performs the marker region specification processing, thereby specifying the display enlargement ratio, the central coordinates, and the range of the marker region. Further, before displaying the marker region in the enlarged manner, the marker region processing unit 206 stores the display enlargement ratio and the coordinates of the currently displayed partial region. After that, the marker region processing unit 206 takes the set transition time for the enlarged display to display the marker region in the enlarged manner so that the marker region fits to the display unit 105.

FIG. 20D illustrates a state in which the marker region is in the middle of being gradually enlarged to the enlarged display as a result of the reception of the double tap in FIG. 20C. This is a state after an elapse of approximately the half of the set transition time for the enlarged display. In this state, the process of step S1510 in the enlarged display processing for the drawn marker, which is illustrated in FIG. 15, is ongoing.

FIG. 20E illustrates a state in which the marker region enlarged display processing is completed from the display state illustrated in FIG. 20D. After that, the marker region processing unit 206 resets the marker display time, and starts the measuring the marker display time again.

The marker region processing unit 206 starts the ending processing for the marker region enlarged display processing after the marker display time exceeds the predetermined time. FIG. 20F illustrates a state in which the enlarged display is in the middle of being gradually ended from the display state illustrated in FIG. 20E. This state is a state after an elapse of approximately the half of the set transition time for ending the enlarged display, and is a state in which the marker is in the middle of being gradually faded and the enlarge display is also in the middle of being returned to the original size.

FIG. 20G illustrates a state in which the ending processing for the marker region enlarged display processing in step S1517 illustrated in FIG. 15 is completed after the display state illustrated in FIG. 20F.

The present exemplary embodiment can achieve the marker region enlarged display processing with the user's intention reflected therein, by displaying the marker region in the enlarged manner based on the coordinates of the position of the double tap that serves as the enlarged display instruction from the user in addition to the coordinate position where the marker is drawn.

### Other Embodiments

Further, the present invention can be also realized by performing the following processing. This processing is processing for supplying software (a program) for realizing the functions of the above-described exemplary embodiments to a system or an apparatus via a network or various kinds of storage media, and causing a computer (or a CPU, a micro processing unit (MPU), or the like) of this system or apparatus to read out and execute the program.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-242442, filed Nov. 28, 2014, which is hereby incorporated by reference herein in its entirety.

What is claimed is:

1. An image display apparatus comprising:
a display unit configured to display an image on a screen;
a marker drawing unit configured to draw a marker on the image displayed by the display unit based on an instruction from a user;
an enlarged display unit configured to display an image of a region containing the marker drawn by the marker drawing unit in an enlarged manner on the screen; and
a reduced display unit configured to display the image of the region containing the marker that is displayed in the enlarged manner by the enlarged display unit in a reduced manner so as to return this image to an enlargement ratio before this image is displayed in the enlarged manner by the enlarged display unit.

2. The image display apparatus according to claim 1, wherein the reduced display unit displays the image displayed on the screen in the reduced manner so as to return this image to the enlargement ratio before the image is displayed in the enlarged manner by the enlarged display unit if a predetermined time has elapsed since the region containing the marker is displayed in the enlarged manner by the enlarged display unit.

3. The image display apparatus according to claim 1, wherein the reduced display unit takes a predetermined transition time to gradually reduce the image displayed on the screen to the reduced display until returning the image to the enlargement ratio before the image is displayed in the enlarged manner by the enlarged display unit if a predetermined time has elapsed since the region containing the marker is displayed in the enlarged manner by the enlarged display unit.

4. The image display apparatus according to claim 3, wherein the reduced display unit gradually fades the marker when taking the predetermined transition time to reduce the image displayed on the screen to the reduced display.

5. The image display apparatus according to claim 1, wherein the reduced display unit displays the image displayed on the screen in the reduced manner so as to return the image to the enlargement ratio before the image is displayed in the enlarged manner by the enlarged display unit if an instruction to end the enlarged display is issued from the user when the region containing the marker is displayed in the enlarged manner by the enlarged display unit.

6. The image display apparatus according to claim 5, wherein the reduced display unit takes a predetermined transition time to gradually reduce the image displayed on the screen to the reduced display until returning the image to the enlargement ratio before this image is displayed in the enlarged manner by the enlarged display unit if the instruction to end the enlarged display is issued from the user when the region containing the marker is displayed in the enlarged manner by the enlarged display unit.

7. The image display apparatus according to claim 6, wherein the reduced display unit gradually fades the marker when taking the predetermined transition time to reduce the image displayed on the screen to the reduced display.

8. The image display apparatus according to claim 1, wherein the enlarged display unit performs control so as to display the image of the region containing the drawn marker, which is determined based on a position of the drawn marker, in the enlarged manner on the screen.

9. The image display apparatus according to claim 1, wherein the enlarged display unit performs control so as to display the image of the region containing the drawn marker, which is determined based on a position of the drawn marker and a position onto which the instruction is issued, in the enlarged manner on the screen.

10. The image display apparatus according to claim 1, further comprising an deletion unit configured to delete the marker after gradually fading the drawn marker if a predetermined display time has elapsed since the user has issued the instruction.

11. The image display apparatus according to claim 1, further comprising a recognition unit configured to recognize a partial region for each document component in a page image,
wherein the image controlled to be displayed on the screen by the display unit is an image of the partial region recognized by the recognition unit.

12. The image display apparatus according to claim 1, wherein the screen is a screen connected to the image display apparatus via a wired or wireless connection.

13. The image display apparatus according to claim 1, wherein the image display apparatus is a mobile terminal.

14. An image display method comprising:
displaying an image on a screen;
drawing a marker on the displayed image based on an instruction from a user;
displaying an image of a region containing the drawn marker in an enlarged manner on the screen as an enlarged image; and
displaying the enlarged image of the region containing the marker in a reduced manner so as to return the enlarged image to an image with an enlargement ratio before the image is displayed in the enlarged manner.

15. A computer readable storage medium storing a program for causing a computer to execute a method, the method comprising:
displaying an image on a screen;
drawing a marker on the displayed image based on an instruction from a user;
displaying an image of a region containing the drawn marker in an enlarged manner on the screen, as an enlarged image; and
displaying the enlarged image of the region containing the marker in a reduced manner so as to return the enlarged image to an image with an enlargement ratio before the image is displayed in the enlarged manner.

16. An image display apparatus comprising:
an acquisition unit configured to acquire a result of an analysis of a plurality of objects included in an image; and
a display control unit configured to display a part of the image that includes a first object, which is a display target in the image on a screen based on a display magnification and a display position set based on an attribute of the first object, and display a part of the image that includes a second object in the image, the second object being indicated by the result of the analysis acquired by the acquisition unit and supposed to be displayed next on the screen based on a display magnification and a display position set based on an attribute of the second object upon receiving an instruction for displaying an object other than the first object on the screen,
wherein, if a marker is drawn on the part of the image that includes the first object displayed on the screen based on an instruction from a user before the instruction for displaying the object other than the first object on the screen is received, the display control unit displays an image of a region containing the marker in an enlarged manner on the screen.

17. An image display method comprising:
acquiring a result of an analysis of a plurality of objects included in an image; and
performing a display control to display a part of the image that includes a first object, which is a display target in the image, on a screen based on a display magnification and a display position set based on an attribute of the first object, and to display a part of the image that includes a second object in the image, the second object being indicated by the result of the analysis acquired by the acquiring and supposed to be displayed next, on the screen based on a display magnification and a display position set based on an attribute of the second object upon receiving an instruction for displaying an object other than the first object on the screen,
wherein, if a marker is drawn on the part of the image that includes the first object displayed on the screen based on an instruction from a user before the instruction for displaying the object other than the first object on the screen is received, an image of a region containing the marker is displayed in an enlarged manner on the screen.
